(19) United States
(12) Patent Application Publication
(10) Pub. No.: US 2016/0031694 A1
(43) Pub. Date: Feb. 4, 2016

(54) WATER DISPENSER

(71) Applicant: KABUSHIKI KAISHA COSMO LIFE, Kakogawa-shi, Hyogo (JP)

(72) Inventor: Yoshinori ORITA, Hyogo (JP)

(21) Appl. No.: 14/776,829

(22) PCT Filed: Dec. 17, 2013
(86) PCT No.: PCT/JP2013/083717

§ 371 Date: Sep. 15, 2015

(30) Foreign Application Priority Data
Mar. 18, 2013 (JP) 2013-055048

(51) Int. Cl. B67D 1/07; B67D 1/12; B67D 1/10; B67D 1/00; B67D 1/08

(52) U.S. Cl. CPC B67D 1/07; B67D 1/0004; B67D 1/0895; B67D 1/10; B67D 1/1279; B67D 1/0878; B67D 1/0857; B67D 2001/075

(57) ABSTRACT

A water dispenser is provided in which a when turned on, timer control of a sterilization operation is automatically started. If an initial input of a predetermined signal by a user is confirmed, after the sterilization operation, an energy saving operation in which the heater is maintained off for a limited time; and a reservation control in which reserved times determined by the timer control are updated based on the time when the input is made; are carried out. If a second or subsequent input is confirmed, the elapsed time since the last sterilization operation until the second or subsequent input is compared with a threshold. If the elapsed time is longer than the threshold, the sterilization operation, the energy saving operation, and the reservation control are carried out. If not, the energy saving operation is carried out without performing the sterilization operation and the reservation control.

### TECHNICAL FIELD

The present invention relates to a water dispenser which supplies drinking water from a replaceable raw water container filled with drinking water such as mineral water.

### BACKGROUND ART

Conventionally, water dispensers have been used primarily in offices and in hospitals. With a growing interest in water safety and health in recent years, however, water dispensers are gaining popularity among ordinary households. A conventional water dispenser is configured such that a replaceable raw water container is set in a housing, and drinking water filled in the raw water container is supplied to a cold water tank and/or a hot water tank housed inside the housing, by gravity or by pumping up using a pump (for example, as one disclosed in the below-identified Patent Documents 1 and 2).

In the above mentioned water dispenser, since drinking water remains in a pipe system and the like which supply drinking water to the cold water tank and/or the hot water tank for a long time, there is a possibility that proliferation of bacteria could occur therein. Drinking water transferred from the raw water container into the hot water tank is heated by a heater and maintained at about 80 to 90 degrees Celsius by an automatic temperature control device, and thus, it is possible to utilize the hot water maintained at that temperature as it is for the sterilization of the water dispenser. As one disclosed in Patent Document 1, a type of water dispenser is known in which hot water in hot water tank is transferred to predetermined portions of a piping system considered to have a risk of proliferation of bacteria, to carry out the sterilization. This type of water dispenser includes a control device which has a function to carry out a sterilization operation in which: a valve control configured to switch valves so as to form a circulation route through which drinking water flowing out of the hot water tank can be circulated through predetermined portions of the piping system back to the hot water tank again; and a pump control configured to drive the pump so as to circulate the drinking water in the hot water tank through the circulation route; are combined; and a function to automatically carry out the sterilization operation at a reserved time. This is because, if the execution of the sterilization operation is entrusted to a user, there is a potential risk that the sterilization operation may not be performed for a long period of time.

However, while the sterilization operation is carried out, there are inconveniences that the supply of drinking water from the raw water container to the hot water tank, or discharging of drinking water cannot be carried out as usual, and that a pump driving sound could occur. Therefore, the reserved time for carrying out the sterilization operation is usually set during the period of time at which discharging of drinking water is less likely to be carried out.

### PRIOR ART DOCUMENTS

### Patent Documents

Patent Document 1 JP 6-48488 A (FIG. 2, paragraphs 0017 to 0025, in particular)

Patent Document 2 JP 2012-162318 A

### SUMMARY OF THE INVENTION

### Problems to be Solved by the Invention

Although it is possible to prevent the proliferation of bacteria to an acceptable level if the sterilization operation is carried out at a frequency of once a week, the drinking water returned to the hot water tank after the sterilization operation will eventually be discharged from the hot water tank and consumed by a user. If the sterilization operation is carried out only once a week, a significant amount of bacterial cadavers could remain in the drinking water in the hot water tank, although harmless. Thus, there is a concern that a user who has recognized this fact may be worried about the sanitation, and evaluate the water dispenser unfavorably. In order to get rid of the user's anxiety, the present inventors have considered that it is preferred to provide an automatic control device to the water dispenser so that it can be ensured that the sterilization operation is carried out frequently, such as once every day.

However, while water dispensers are provided to users in households, in the order of thousands and tens of thousands, the daily life cycle of each user, such as the time to go to bed, wake up, leave home for work, and come home from work, varies depending on the individual household. In cases where a clock is installed to a water dispenser so that the reserved times for carrying out the sterilization operation are automatically set based on the actual time, it is possible to set each of the reserved times accurately, within a narrow range of time in the individual daily life cycle, during which execution of the sterilization operation does not cause any inconveniences. However, the cost of providing a clock to a water dispenser is higher than providing a timer control.

On the other hand, in cases where the sterilization operation is carried out based on a timer control, although it is possible to at least ensure that the sterilization operation is carried out at appropriate intervals, based on a predetermined routine configured to determine the reserved time, as the frequency to perform the sterilization operation increases, the possibility that the reserved time for carrying out the sterilization operation could be set during the period of time not suited to the particular daily life cycle also increases, depending on the starting time of the timer, thereby resulting in repeated occurrence of inconvenience during the sterilization operation.

Accordingly, an object of the present invention is to provide a water dispenser in which the sterilization operation can be more easily carried out at timings suited to the daily life cycle of a user, while ensuring by the timer control that the sterilization operation is carried out at appropriate intervals.

### Means for Solving the Problems

In order to solve the above mentioned problems, the present invention presupposes:

A water dispenser comprising:

a hot water tank configured to store high temperature drinking water to be discharged to outside of the water dispenser;

a heater configured to heat drinking water in the hot water tank transferred from a replaceable raw water container; and

a control device configured to carry out the sterilization operation in which:
a valve control configured to switch valves so as to form a circulation route through which drinking water flowing out of the hot water tank can be circulated through predetermined portions of a piping system back to the hot water tank; and
a pump control configured to drive a pump so as to circulate the drinking water in the hot water tank through the circulation route; are combined,

wherein the control device is configured to initiate the sterilization operation at reserved times determined by the timer control.

In order to solve the above mentioned problems, the control device according to the present invention is configured to carry out a basic reservation control configured to automatically start a timer control of the sterilization operation according to a predetermined routine, when the water dispenser is turned on.

In the timer control, the reserved times at which the sterilization operation is started by the timer is determined according to the predetermined routine.

Therefore, once the water dispenser is turned on, it can be ensured that the sterilization operation is carried out at appropriate intervals which are determined by the manufacturer of the water dispenser to be at least sufficient to secure the sanitation of the water dispenser.

If an input of a predetermined signal via a switch operation by a user is confirmed, the control device according to the present invention is configured: if the input is a first input after the water dispenser has been turned on, to carry out: the sterilization operation; an energy saving operation in which the heater is maintained off after the completion of the sterilization operation, and turned on when a prescribed period of time has elapsed since the input; and a reservation control configured to update reserved times determined by the timer control according to the predetermined routine based on a reference time at which the input is made; and

if the input is a second or subsequent input after the water dispenser is turned on, to compare an elapsed time since an input of the predetermined signal which initiated a last sterilization operation until said second or subsequent input with a threshold value; and
to carry out the sterilization operation, the energy saving operation, and the reservation control, if a relation: elapsed time>threshold value is satisfied; and to carry out the energy saving operation without performing the sterilization operation and the reservation control, if a relation: elapsed time≦threshold value is satisfied.

The timing when a user decides to turn off the heater of the hot water tank is considered to be the time of the day where the user is less likely to use hot water and to discharge drinking water. In other words, the execution of the sterilization operation is less likely to cause inconveniences at that time of the day.

Therefore, if the sterilization operation is carried out at the timing when the user has operated the switch to input the signal to initiate the energy saving operation, it is possible to carry out the sterilization operation at the timing suited to the daily life cycle of the user. If the energy saving operation is carried out after the completion of the sterilization operation, the temperature of drinking water to be circulated during the sterilization operation can be maintained at a temperature appropriate for sterilization.

In general, a preferred timing to turn off the heater in an average daily life cycle is considered to be the period of time during which the user is in bed, and/or the period of time during which the user is regularly away from home, that is, the period of time from the time at which the user leaves home for school or work until the time the user comes home. In other words, since the opportunities for the user to utilize the energy saving operation are expected to occur virtually every day, corresponding to the daily life cycle of the user, the opportunities to carry out the sterilization operation at the timing when the user utilizes the energy saving operation based on his/her daily life cycle are also expected to occur frequently. Therefore, it is possible to repeatedly reschedule the reserved time for carrying out the sterilization operation determined by the timer control, and to carry out the sterilization operation at timings suited to the daily life cycle of the user.

It can be described as follows. When the input is made for the first time after the water dispenser is turned on, by updating the reserved time determined by the timer control based on the reference time at which the input is made, the sterilization operation can be carried out at the timings suited to the daily life cycle of the user. In addition, it is also possible to continuously ensure that the sterilization operation is carried out at appropriate intervals such that the sanitation of the water dispenser is maintained, even if each of the reserved times for the next time onwards, for carrying out the sterilization operation, is determined without taking the execution history into account.

However, if the user employs the energy saving operation twice every day, at the time at which the user goes to bed and at the time at which the user leaves home regularly, and if the sterilization operation is carried out every time when the energy saving operation is employed, the sterilization operation is carried out excessively, thereby causing the reduction in the energy saving benefits.

Therefore, when the input which corresponds to the second or subsequent input after the water dispenser is turned on is made, the control device is configured to compare an elapsed time since the input which initiated the immediate last sterilization operation until the second or subsequent input with a threshold value, and to carry out the sterilization operation, the energy saving operation, and the reservation control, if the relation: elapsed time>threshold value is satisfied; and to carry out the energy saving operation without performing the sterilization operation and the reservation control, if the relation: elapsed time≦threshold value is satisfied. With this arrangement, by presetting an adequate threshold value determined by the manufacture, the sterilization operation can be carried out repeatedly at the timings suited to the daily life cycle of the user, while avoiding the situation where the sterilization operation is carried out excessively. At the same time, it is possible to continuously ensure that the sterilization operation is repeatedly carried out at appropriate intervals according to the predetermined routine such that the sanitation of the water dispenser is maintained, while repeatedly rescheduling the reserved time determined by the timer control for carrying out the sterilization operation. If the reservation control is carried out when the relation: elapsed time≦threshold value is satisfied, there is a potential risk that the update of the reservation occurs repeatedly without carrying out the sterilization operation, thereby invalidating the assurance that the sterilization operation is carried out at appropriate intervals based on the predetermined routine. On the other hand, if the reservation control is not carried out when the relation: elapsed time≦threshold value is satisfied, it can be continuously ensured that the sterilization operation is carried out at appropriate intervals.

It is preferred that the above described predetermined routine be configured such that, when the reserved time is determined for the first time based on the reference time, the reserved time is set at a time which is later than 24 hours after the reference time by a specified period of time, and when the reserved times are determined for the second time onwards, each of the reserved times is set at a time which is 24 hours after the immediate last reserved time. With this arrangement, it can be ensured that the sterilization operation is carried out once every day at the same time, except for the first reservation.

The reason for setting the first reserved time at the time which is later than 24 hours after the reference time by the specified period of time, is because, even if the actual time at which the energy saving operation is employed for the first time happens to be the timing inconsistent with the regular daily life cycle of the user, the reserved times to be determined for the second time onwards can be adjusted to better suit the daily life cycle of the user.

For example, the above mentioned specified period of time is preferably determined to be 2 hours or less. If the specified period of time is greater than 2 hours, the next reserved time may be set at a timing not suited the daily life cycle of the user. The period of time during which the user is in bed and/or the period of time during which the user is regularly away from home are likely to shift within the range of one hour before and after the regular time. This is because, small events, such as viewing or listening a particular program of broadcasting, making an excursion for shopping and the like, can occur unexpectedly. If the specified period of time is determined to be 2 hours or less, even if the actual time to employ the energy saving operation for the first time happens to be inconsistent with the regular daily life cycle of the user, the reserved times to be determined for the next time onwards can be adjusted to suit the daily life cycle of the user.

For example, the above mentioned threshold value is preferably determined to be 14 hours. Since the energy saving operation is expected to be employed at the time at which the user goes to bed and/or the time at which the user is leaves home regularly, if the threshold value is set to 14 hours, the execution of the sterilization operation and the update of the reserved time determined by the timer control to carry out the sterilization operation can be performed either during the period of time during which the user is in bed or the period of time during which the user is regularly away from home, every day. This serves to avoid the situation in which the sterilization operation is carried out excessively, such as twice a day, while maintaining the sterilization operation schedule suited to the daily life cycle of the user without compromising the sanitation of the water dispenser.

For example, the above mentioned prescribed period of time is preferably determined to be 6 hours. With this arrangement, it is possible to re-heat the drinking water in the hot water tank sufficiently before it is time for the user to wake up or to come home, corresponding to the average length of the period of time during which the user is in bed or the period of time during which the user is regularly away from home.

### Effect of the Invention

As described above, the present invention provides a water dispenser comprising a hot water tank configured to store high temperature drinking water to be discharged to outside of the water dispenser, a heater configured to heat drinking water in the hot water tank transferred from a replaceable raw water container, and a control device configured to carry out a sterilization operation in which a valve control configured to switch valves so as to form a circulation route through which drinking water flowing out of the hot water tank can be circulated through predetermined portions of a piping system back to the hot water tank, and a pump control configured to drive a pump so as to circulate the drinking water in the hot water tank through the circulation route are combined, wherein the control device is configured, when the water dispenser is turned on, to carry out a basic reservation control configured to automatically start a timer control of the sterilization operation according to a predetermined routine; the control device is further configured, if, after the power of the water dispenser is turned on, a first input of a predetermined signal via a switch operation by a user is confirmed, to carry out: the sterilization operation; an energy saving operation configured such that the heater is maintained off after the completion of the sterilization operation, and the heater is turned on when a prescribed period of time has elapsed since the first input; and a reservation control configured to update reserved times determined by the timer control according to the predetermined routine based on a reference time at which the first input is made; and the control device is further configured, if a second or subsequent input of the predetermined signal is confirmed after the power of the water dispenser is turned on, to compare an elapsed time since an input which initiated a last sterilization operation until said second or subsequent input with a threshold value; and to carry out the sterilization operation, the energy saving operation, and the reservation control, if a relation: elapsed time>threshold value is satisfied; and to carry out the energy saving operation without performing the sterilization operation and the reservation control, if a relation: elapsed time≦threshold value is satisfied. Therefore, it is possible to carry out the sterilization operation at the timings suited to the daily life cycle of the user, more easily, while ensuring by the timer control that the sterilization operation is carried out at appropriate intervals.

### BRIEF DESCRIPTION OF THE DRAWINGS

FIG. 1 is a sectional view of a water dispenser embodying the present invention, when it is in a normal operation mode.

FIG. 2 is a sectional view of the water dispenser shown in FIG. 1, when it is in a sterilization operation mode.

FIG. 3 is a sectional view of the water dispenser shown in FIG. 1, when it is new and unused (when a cold water tank, a hot water tank and a buffer tank are all empty).

FIG. 4 is a sectional view illustrating the state in which a raw water container is set to the water dispenser shown in FIG. 3, and a raw water pumping operation is being carried out.

FIG. 5 is a sectional view of the water dispenser shown in FIG. 4, illustrating the state in which an unheated circulation operation is being carried out after the completion of the raw water pumping operation.

FIG. 6 is a sectional view of the water dispenser shown in FIG. 1, illustrating the state in which low temperature drinking water is being discharged from the cold water tank.

FIG. 7 is a sectional view of the water dispenser shown in FIG. 1, illustrating the state in which high temperature drinking water is being discharged from the hot water tank.

FIG. 8 is a sectional view showing the vicinity of a container holder shown in FIG. 1, illustrating the state in which the container holder has been pulled out of a housing.

FIG. 9 (a) is an enlarged sectional view of the water dispenser shown in FIG. 7, showing the vicinity of the guide plate; and FIG. 9 (b) is a sectional view of the water dispenser shown in FIG. 9 (a), taken along the line B-B.

FIG. 10 is an enlarged sectional view of the water dispenser shown in FIG. 1, illustrating the state in which drinking water in the hot water tank is heated by a heater, and air dissolved in the drinking water is turned into air bubbles and accumulated in the upper portion of the hot water tank.

FIG. 11 is a block diagram showing the scheme of a control device of the water dispenser shown in FIG. 1.

FIG. 12 is a flow diagram illustrating how a water level control of the cold water tank is carried out by the control device shown in FIG. 11.

FIG. 13 is a flow diagram illustrating how a heater control of the hot water tank is carried out by the control device shown in FIG. 11.

FIG. 14 is a flow diagram illustrating how a water circulation control is carried out by the control device shown in FIG. 11.

FIG. 15 is a flow diagram illustrating how the supply of drinking water to the empty hot water tank is carried out by the control device shown in FIG. 11.

FIG. 16 is a flow diagram illustrating the timings at which the sterilization operation and an energy saving operation are initiated by the control device shown in FIG. 11.

FIG. 17 is a flow diagram showing the specific detail of a predetermined routine in a reservation control carried out by the control device shown in FIG. 11.

FIG. 18 is a flow diagram showing the specific detail of the energy saving operation carried out by the control device shown in FIG. 11.

### MODE FOR CARRYING OUT THE INVENTION

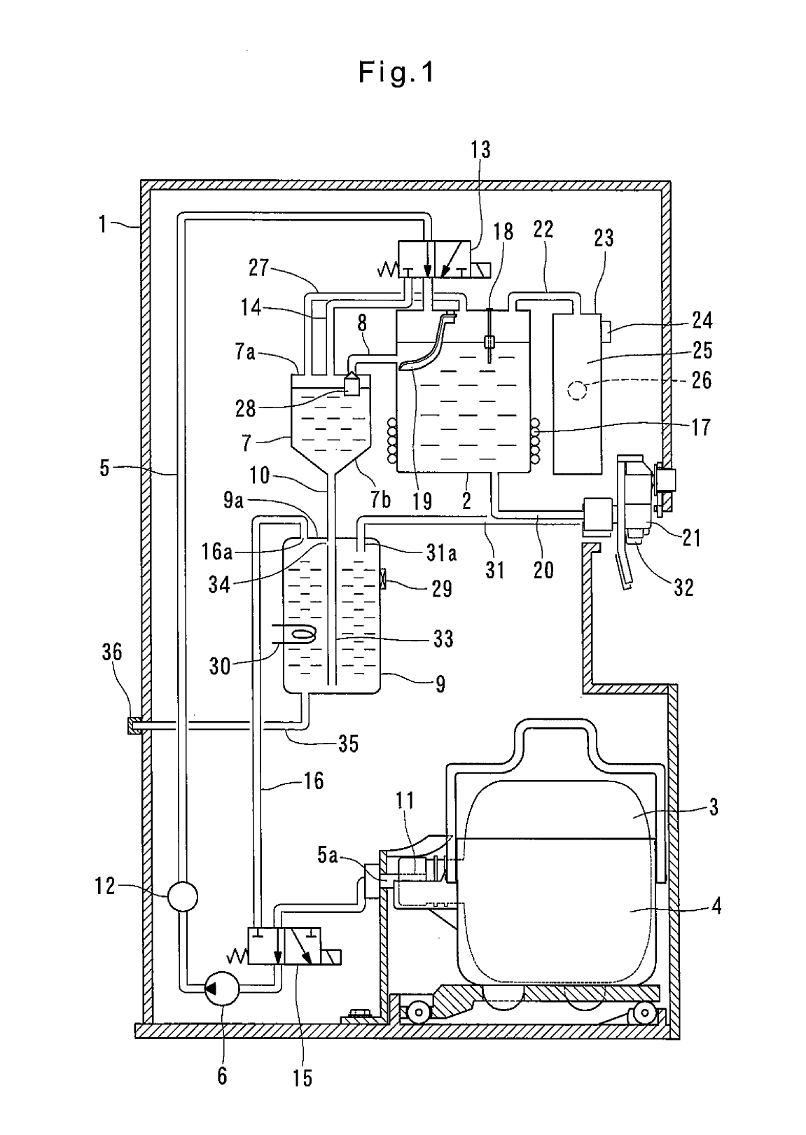

A water dispenser embodying the present invention is shown in FIG. 1. This water dispenser includes: a housing 1; a cold water tank 2 configured to store low temperature drinking water to be discharged to the outside of the housing 1, a replaceable raw water container 3 filled with drinking water to be supplied to the cold water tank 2; a container holder 4 configured to support the raw water container 3; a raw water pumping pipe 5 which allows communication between the raw water container 3 and the cold water tank 2; a pump 6 provided at an intermediate portion of the raw water pumping pipe 5; a buffer tank 7 provided laterally of the cold water tank 2; a buffer tank water supply pipe 8 through which drinking water in the cold water tank 2 is transferred into the buffer tank 7; a hot water tank 9 configured to store high temperature drinking water to be discharged to the outside of the housing 1; and a hot water tank water supply pipe 10 which allows communication between the buffer tank 7 and the hot water tank 9.

The raw water pumping pipe 5 has at its upstream end a joint portion 5a configured to be detachably connected to a water outlet port 11 of the raw water container 3. The end portion of the raw water pumping pipe 5 on the downstream side thereof is connected to the cold water tank 2. The raw water pumping pipe 5 extends downward from the joint portion 5a, and is then redirected upward so that it passes through a position lower than the joint portion 5a. The pump 6 is provided in the raw water pumping pipe 5 at its portion lower than the joint portion 5a.

The pump 6 is configured to transfer drinking water in the raw water pumping pipe 5 from the side of the raw water container 3 toward the cold water tank 2, thereby pumping out drinking water from the raw water container 3 through the raw water pumping pipe 5. A diaphragm pump can be used as the pump 6. While not shown, the diaphragm pump includes a diaphragm which reciprocates; a pump chamber whose volume is increased and decreased by the reciprocation of the diaphragm, and including a suction port and a discharge port; a suction side check valve provided at the suction port and configured to allow only the flow of water into the pump chamber; and a discharge side check valve provided at the discharge port and configured to allow only the flow of water out of the pump chamber. The diaphragm pump sucks in drinking water through the suction port when the volume of the pump chamber is increasing due to the movement of the diaphragm in one direction, and discharges drinking water from the discharge port when the volume of the pump chamber is decreasing due to the movement of the diaphragm in the other direction.

Further, the pump 6 may be a gear pump or a screw pump. While not shown, the gear pump includes a casing; a pair of gears meshing with each other and housed inside the casing; and a suction chamber and a discharge chamber defined by the meshing portions of the pair of gears in the casing. The gear pump transfers drinking water trapped between the tooth spaces of the pair of gears and the inner surface of the casing of the gear pump from the side of the suction chamber toward the discharge chamber, by the rotation of the gears.

A flow rate sensor 12 is provided in the raw water pumping pipe 5 on the discharge side of the pump 6. When the flow rate sensor 12 detects that there is no drinking water flowing in the raw water pumping pipe 5 while the pump 6 is in operation, a container-replacement lamp placed on the front surface of the housing 1, which is not shown, is turned on to notify a user that the raw water container 3 needs to be replaced.

A first three-way valve 13 is provided in the raw water pumping pipe 5 at its portion between the pump 6 and the cold water tank 2 (preferably, at the end portion of the raw water pumping pipe 5 on the side of the cold water tank 2). Although the figures show an example in which the first three-way valve 13 is disposed at a position away from the cold water tank 2, the first three-way valve 13 may be directly connected to the cold water tank 2. A first sterilization pipe 14 is connected to the first three-way valve 13 and allows communication between the first three-way valve 13 and the buffer tank 7. The end portion of the first sterilization pipe 14 on the side of the buffer tank 7 is connected to an upper surface 7a of the buffer tank 7.

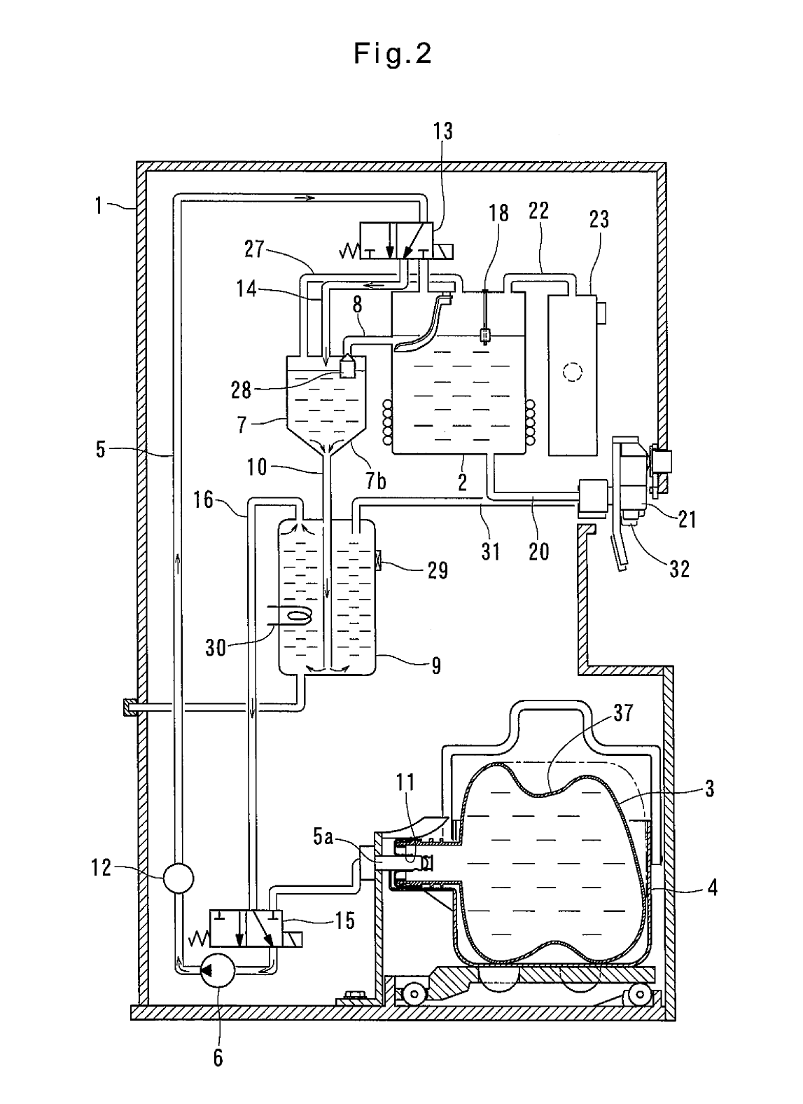

The first three-way valve 13 is configured to be switchable between a normal flow path position (see FIG. 1) and a sterilization flow path position (see FIG. 2). When switched to the normal flow path position, the first three-way valve 13 allows communication between the pump 6 and the cold water tank 2, while blocking communication between the pump 6 and the first sterilization pipe 14; and when switched to the sterilization flow path position, the first three-way valve 13 blocks communication between the pump 6 and cold water tank 2, and allows communication between the pump 6 and the first sterilization pipe 14. In this embodiment, the first three-way valve 13 is a solenoid valve configured to switch from the normal flow path position to the first sterilization flow path position when energized, and from the sterilization flow path position to the normal flow path position when de-energized.

A second three-way valve 15 is provided in the portion of the raw water pumping pipe 5 between the pump 6 and the raw water container 3 (preferably, at the end portion of the raw water pumping pipe 5 on the side of the raw water container 3). Although the figures show an example in which the second three-way valve 15 is disposed at a position away from the joint portion 5a, the second three-way valve 15 may be directly connected to the joint portion 5a. A second sterilization pipe 16 is connected to the second three-way valve 15 and configured to allow communication between the second three-way valve 15 and the hot water tank 9. The end portion of the second sterilization pipe 16 on the side of the hot water tank 9 is connected to an upper surface 9a of the hot water tank 9.

The second three-way valve 15 is configured to be switchable between a normal flow path position (see FIG. 1) and a sterilization flow path position (see FIG. 2). When switched to the normal flow path position, the second three-way valve 15 allows communication between the pump 6 and the raw water container 3, while blocking communication between the pump 6 and the second sterilization pipe 16; and when switched to the sterilization flow path position, the second three-way valve 15 blocks communication between the pump 6 and the raw water container 3, and allows communication between the pump 6 and the second sterilization pipe 16. In this embodiment, the second three-way valve 15 is a solenoid valve as with the first three-way valve 13, and configured to switch from the normal flow path position to the sterilization flow path position when energized, and from the sterilization flow path position to the normal flow path position when de-energized.

Each of the first three-way valve 13 and the second three-way valve 15 shown in the figures may be replaced by a three-way valve assembly comprising a plurality of two-way valves to achieve the same effect.

The cold water tank 2 contains air and drinking water in upper and lower layers. A cooling device 17 is attached to the cold water tank 2, and is configured to cool the drinking water contained in the cold water tank 2. The cooling device 17 is positioned at the lower outer periphery of the cold water tank 2, so that the drinking water inside the cold water tank 2 is maintained at a low temperature (about 5 degrees Celsius).

A water level sensor 18 is installed in the cold water tank 2 and configured to detect the water level of the drinking water accumulated in the cold water tank 2. When the water level detected by the water level sensor 18 falls to a predetermined level, the pump 6 is actuated to pump up drinking water from the raw water container 3 into the cold water tank 2.

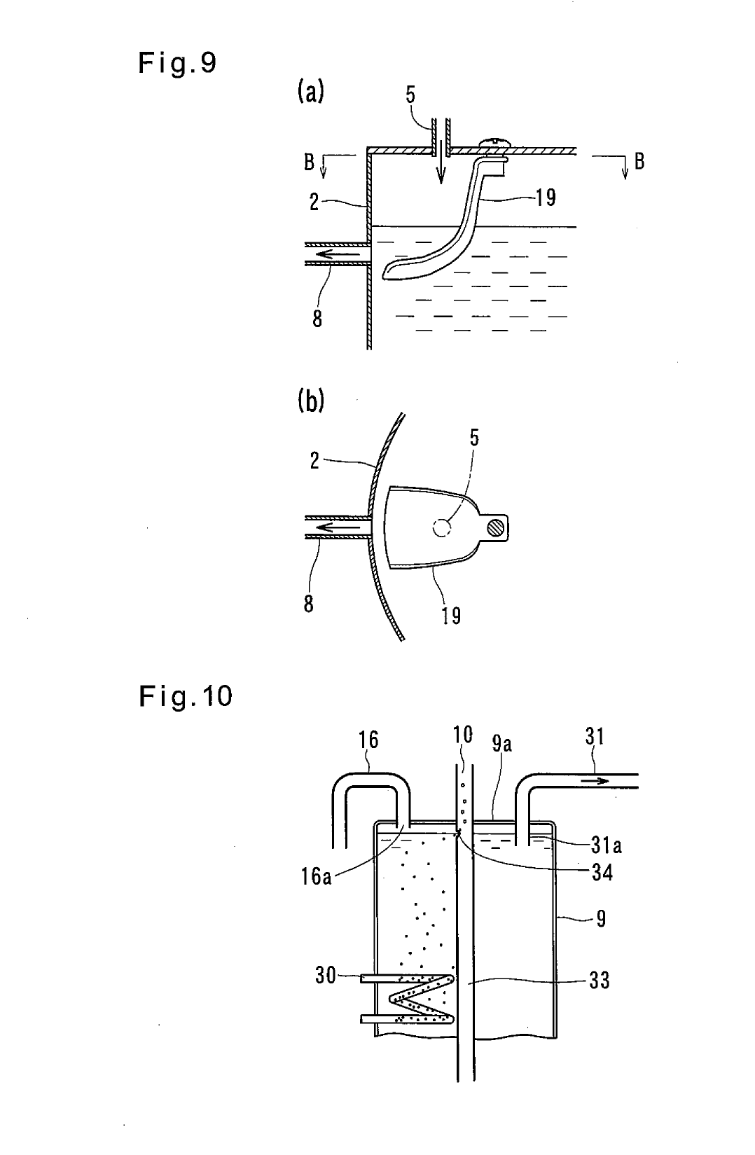

As shown in FIGS. 9 (a) and (b), a guide plate 19 is provided inside the cold water tank 2, and configured to redirect the flow of the drinking water flowing from the raw water pumping pipe 5 into the cold water tank 2 in the vertical direction when drinking water is pumped up from the raw water container 3 into the cold water tank 2, to a horizontal direction. The guide plate 19 prevents the low temperature drinking water accumulated in the lower portion of the cold water tank 2 from being stirred by the normal temperature drinking water flowing into the cold water tank 2 from the raw water pumping pipe 5. Further, as shown in FIG. 9 (a), the guide plate 19 is provided with a slope ascending gradually from the position slightly lower than the end portion of the buffer tank water supply pipe 8 on the side of the cold water tank 2 toward the end portion of the raw water pumping pipe 5 on the side of the cold water tank 2. This slope is configured such that the flow of drinking water flowing from the raw water pumping pipe 5 into the cold water tank 2 is redirected to the flow toward the buffer tank water supply pipe 8.

As shown in FIG. 1 a cold water discharging pipe 20 is connected to the bottom surface of the cold water tank 2 such that low temperature drinking water in the cold water tank 2 can be discharged to the outside of the housing 1 through the cold water discharging pipe 20. The cold water discharging pipe 20 is provided with a cold water cock 21 capable of being operated from outside the housing 1, and low temperature drinking water can be discharged from the cold water tank 2 into a cup or the like by opening the cold water cock 21. The capacity of the cold water tank 2 to hold drinking water is less than the capacity of the raw water container 3, and is about from 2 to 4 liters.

An air sterilization chamber 23 is connected to the cold water tank 2 through an air introduction passage 22. The air sterilization chamber 23 includes a hollow casing 25 provided with an air inlet port 24; and an ozone generator 26 provided within the casing 25. The ozone generator 26 may be, for example, a low-pressure mercury lamp which irradiates ultraviolet light to the oxygen in the air to convert oxygen to ozone, or a silent discharge apparatus in which an AC voltage is applied between an opposed pair of electrodes covered with insulators to convert oxygen between the electrodes to ozone. The air sterilization chamber 23 is maintained in a state in which the casing 25 thereof is filled with ozone at all times, by energizing the ozone generator 26 at regular intervals to generate ozone.

When the water level in the cold water tank 2 falls, air is introduced into the cold water tank 2 through the air introduction passage 22, such that the pressure in the cold water tank 2 is maintained at atmospheric pressure. Since air introduced into the cold water tank 2 is sterilized with ozone by passing through the air sterilization chamber 23, the air inside the cold water tank 2 is maintained clean.

The buffer tank 7 contains air and drinking water in upper and lower layers. An air pipe 27 is connected to the upper surface of the buffer tank 7. The air pipe 27 maintains the pressure inside the buffer tank 7 at atmospheric pressure by allowing communication between the air layer in the buffer tank 7 and the air layer in the cold water tank 2.

The buffer tank water supply pipe 8 allows communication between the air layer in the buffer tank 7 and the cold water tank 2. The end portion of the buffer tank water supply pipe 8 on the side of the cold water tank 2 opens to the upper layer portion of the drinking water contained in the cold water tank 2, such that drinking water in the upper layer portion is introduced into the buffer tank water supply pipe 8. This allows the upper layer portion of the drinking water in the cold water tank 2 to be supplied into the buffer tank 7, and prevents the low temperature drinking water accumulated in the lower portion of the cold water tank 2 from flowing into the buffer tank 7. Thus, the drinking water in the cold water tank 2 can be effectively maintained at a low temperature.

The end portion of the buffer tank water supply pipe 8 on the side of the buffer tank 7 is connected to the upper surface 7a of the buffer tank 7. A float valve 28 is provided at the end portion of the buffer tank water supply pipe 8 on the side of the buffer tank 7, and configured to open and close according to the water level in the buffer tank 7. In particular, the float valve 28 allows the flow of water through the buffer tank water supply pipe 8 when the water level in the buffer tank 7 falls below a predetermined level, and blocks the flow of water therethrough when the water level in the buffer tank 7 rises to the predetermined level.

The capacity of the buffer tank 7 to hold drinking water is less than the capacity of the hot water tank 9, and is about from 0.2 to 0.5 liters. A bottom surface 7b of the buffer tank 7 is formed in the shape of a cone with a slope sloping downward toward its center. The hot water tank water supply pipe 10 is connected to the center of the bottom surface 7b of the buffer tank 7. The hot water tank water supply pipe 10 is connected to the hot water tank 9 disposed below the buffer tank 7. The bottom surface 7b of the buffer tank 7 is formed in the shape of a cone, so that, when the sterilization operation to be described later is carried out, high temperature drinking water is able to reach the portion of the bottom surface 7b along the outer periphery of the buffer tank 7, leaving no portion unsterilized.

The hot water tank 9 is completely filled with drinking water. The hot water tank 9 has mounted thereto a temperature sensor 29 configured to directly or indirectly detect the temperature of the drinking water in the hot water tank 9, and a heater 30 configured to directly or indirectly heat the drinking water in the hot water tank 9. As the temperature detected by the temperature sensor 29 decreases and increases, the heater 30 is turned on and off so that the temperature of the drinking water in the hot water tank 9 can be maintained high (about 90 degrees Celsius). In the figures, an example is shown in which a bimetal switch is used as the temperature sensor 29. The bimetal switch indirectly detects the temperature of the drinking water in the hot water tank 9, by detecting the temperature of the outer wall surface of the hot water tank 9. Further, although the figures show an example in which a sheathed heater is used as the heater 30, a band heater may be used instead. The sheathed heater is a heating device including a heating wire housed in a metal pipe and configured to generate heat when energized, and is installed to extend through the wall of the hot water tank 9, and into the interior of the hot water tank 9. A band heater is a cylindrical heat generator in which a heating wire which generates heat when energized is embedded, and would be attached around the outer periphery of the hot water tank 9 in close contact therewith.

A hot water discharging pipe 31 is connected to the upper surface 9a of the hot water tank 9 such that high temperature drinking water accumulated in the upper portion of the hot water tank 9 can be discharged to the outside of the housing 1 through the hot water discharging pipe 31. The hot water discharging pipe 31 is provided with a hot water cock 32 capable of being operated from outside the housing 1, and high temperature drinking water can be discharged from the hot water tank 9 into a cup or the like by opening the hot water cock 32. When drinking water is discharged from the hot water tank 9, drinking water in the buffer tank 7 is introduced into the hot water tank 9 through the hot water tank water supply pipe 10, due to its own weight. Accordingly, the hot water tank 9 is maintained fully filled at all times. The capacity of the hot water tank 9 to hold drinking water is about from 1 to 2 liters.

The hot water tank water supply pipe 10 includes an in-tank pipe portion 33 extending downward from the upper surface 9a of the hot water tank 9 through the interior of the hot water tank 9. The in-tank pipe portion 33 has an open lower end near the bottom surface of the hot water tank 9. At the position close to the upper surface 9a of the hot water tank 9, the in-tank pipe portion 33 includes a small hole 34 through which the interior and the exterior of the in-tank pipe portion 33 communicate with each other.

An end portion 31a of the hot water discharging pipe 31 on the side of the hot water tank 9 extends downward through the upper surface 9a of the hot water tank 9 and into the hot water tank 9, and has an opening inside the hot water tank 9 at a position spaced apart downward from the upper surface 9a of the hot water tank 9 (for example, at a position about from 5 to 15 mm below the upper surface 9a of the hot water tank 9). The small hole 34 provided in the in-tank pipe portion 33 of the hot water tank water supply pipe 10 has an opening in the hot water tank 9 at a position higher than the opening of the end portion 31a of the hot water discharging pipe 31 on the side of the hot water tank 9. The end portion 16a of the second sterilization pipe 16 on the side of the hot water tank 9 has an opening in the hot water tank 9 at a position higher than the small hole 34 provided in the in-tank pipe portion 33 of the hot water tank water supply pipe 10.

A drain pipe 35 is connected to the bottom surface of the hot water tank 9, and extends to the exterior of the housing 1. The outlet port of the drain pipe 35 is closed with a plug 36. However, an on-off valve may be provided instead of the plug 36.

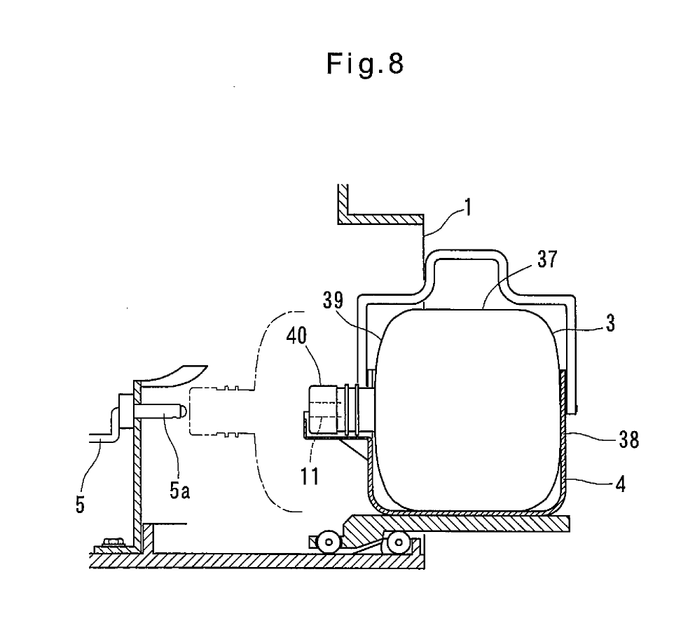

As shown in FIG. 8, the raw water container 3 includes a hollow cylindrical trunk portion 37; a bottom portion 38 provided at one end of the trunk portion 37; and a neck portion 40 provided on the other end of the trunk portion 37 through a shoulder portion 39, and including the water outlet port 11. The trunk portion 37 of the raw water container 3 is formed flexible so as to be collapsible as the amount of water remaining in the raw water container 3 decreases. The raw water container 3 is made by blow molding of polyethylene terephthalate (PET) resin. The capacity of the raw water container 3 is about from 10 to 20 liters when fully filled.

The raw water container 3 may be a bag made of a resin film, placed in a box such as a corrugated carton (so called “bag-in-box”), which bag is provided with a connecting member including a water outlet port 11, attached thereto by heat welding or the like.

The container holder 4 is supported so as to be movable in a horizontal direction between a stowed position (the position shown in FIG. 1) in which the raw water container 3 is stowed inside the housing 1, and a pulled out position (the position shown in FIG. 8) in which the raw water container 3 is moved out of the housing 1. The joint portion 5a is fixed in position inside the housing 1 such that the joint portion 5a is disconnected from the water outlet port 11 of the raw water container 3 when the container holder 4 is moved to the pulled out position, as shown in FIG. 8, and the joint portion 5a is connected to the water outlet port 11 of the raw water container 3 when the container holder 4 is moved to the stowed position, as shown in FIG. 1.

As the raw water pumping pipe 5 (excluding the joint portion 5a), a silicone tube can be used. However, since silicone has an oxygen permeability, proliferation of bacteria is more likely to occur in the raw water pumping pipe 5 due to the oxygen in the air that permeates through the silicone tube. Therefore, a metal pipe (such as a stainless steel pipe or a copper pipe) can be used as the raw water pumping pipe 5. With this arrangement, permeation of air through the wall of the raw water pumping pipe 5 can be prevented, thereby allowing for an effective prevention of the proliferation of bacteria in the raw water pumping pipe 5. In addition, heat resistance of the raw water pumping pipe 5 can also be secured when hot water is circulated therethrough. The use of a polyethylene tube or a heat-resistant, rigid polyvinyl chloride tube as the raw water pumping pipe 5 also allows for preventing the permeation of air through the pipe wall of the raw water pumping pipe 5, thereby preventing the proliferation of bacteria in the raw water pumping pipe 5.

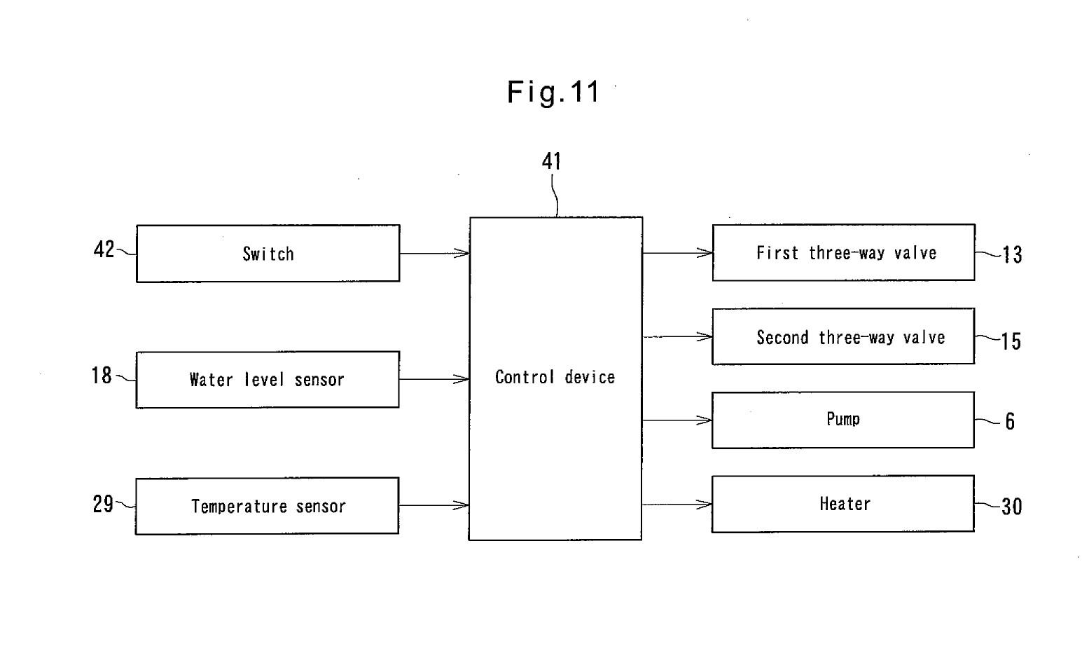

The first three-way valve 13, the second three-way valve 15, the pump 6, and the heater 30 are controlled by a control device 41 shown in FIG. 11. The following signals are input to the control device 41: a signal sent from a switch 42 when a user operates the switch 42; a signal sent from the water level sensor 18, indicating the water level of the drinking water accumulated in the cold water tank 2; a signal sent from the temperature sensor 29, indicating the temperature of the drinking water in the hot water tank 9. Based on these signals, the following signals are output from the control device 41: a control signal to drive and stop the pump 6; a control signal to turn on and off the heater 30; a control signal to switch the position of the first three-way valve 13; and a control signal to switch the position of the second three-way valve 15.

From the switch 42, a predetermined signal to start an energy saving operation is input to the control device 41. The switch 42 is, for example, a push button disposed at the front surface of the housing 1. Only when a user operates the switch 42 in a predetermined manner, the above predetermined signal is input to the control device 41. For example, the water dispenser may be configured such that the switch 42 is also used to turn on the water dispenser, and only a signal generated when the switch 42 is pressed for a predetermined period of time or longer is recognized as the predetermined signal to start the energy saving operation, while a signal generated when the switch 42 is pressed for a shorter period of time is recognized as the signal only to turn on the water dispenser.

It will now be described how the control device 41 works.

During the normal operation mode, the control device 41 carries out a water level control configured to maintain the water level in the cold water tank 2 within a predetermined range, and a heater control configured to maintain the temperature of the drinking water in the hot water tank 9 at a high temperature, with the first three-way valve 13 and the second three-way valve 15 switched to the respective normal flow path positions, as shown in FIG. 1.

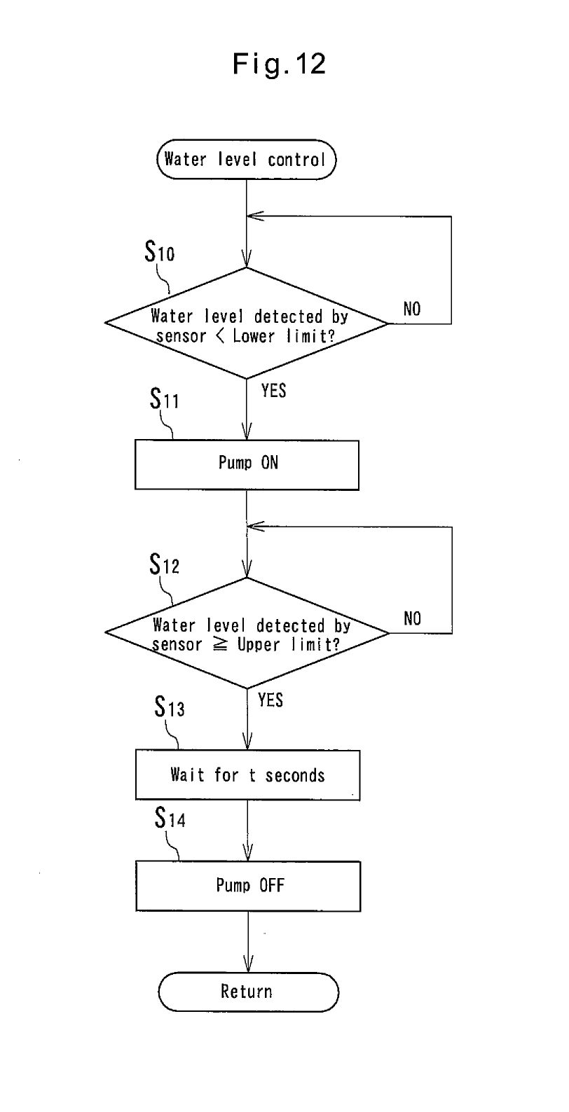

The water level control of the cold water tank 2 is carried out, for example, according to the routine shown in FIG. 12. In this routine, when the water level in the cold water tank 2 falls below a predetermined lower limit water level, the pump 6 is driven to pump up drinking water from the raw water container 3 into the cold water tank 2, so that the water level in the cold water tank 2 is increased (steps S₁₀ and S₁₁). When the water level in the cold water tank 2 is increased to reach a predetermined upper limit water level, the pump 6 is deactivated after waiting for a predetermined period of time: t seconds (steps S₁₂, S₁₃ and S₁₄).

The reason to wait for t seconds in step S₁₃ is to prevent chattering due to the waves generated on the water surface. If a level switch is used as the water level sensor 18 for example, since the level switch is only capable of distinguishing between whether the current water level in the cold water tank 2 is less than a certain water level, or equal to or greater than the certain water level, the upper limit water level and the lower limit water level will be the same, thereby causing the problem of chattering to be more pronounced. If a sensor capable of distinguishing between two or more water levels is used as the water level sensor 18, since there is a difference between the upper limit water level and the lower limit water level, it is possible to omit step S₁₃.

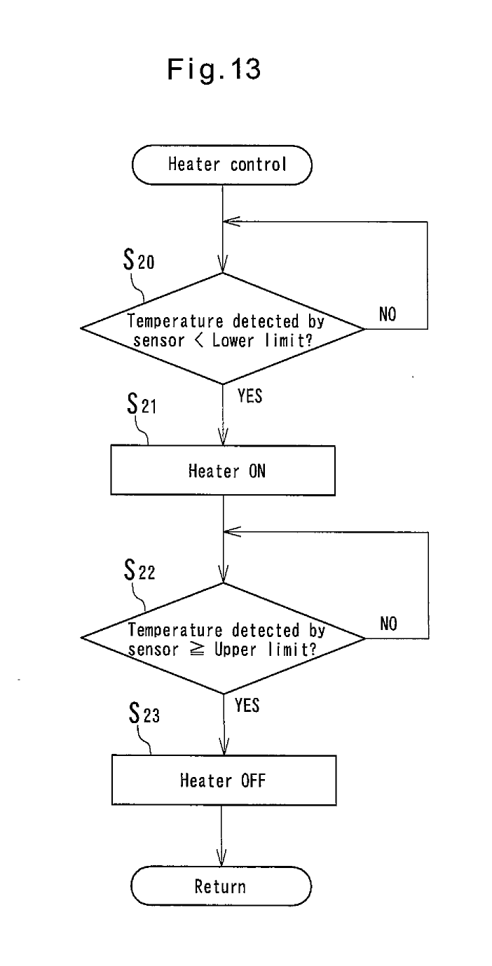

The heater control of the hot water tank 9 is carried out, for example, according to the routine shown in FIG. 13. In this routine, first, when the temperature sensor 29 detects that the temperature in the hot water tank 9 has fallen below a predetermined lower limit temperature, the heater 30 is turned on to raise the temperature in the hot water tank 9 (steps S₂₀ and S₂₁). When the temperature sensor 29 detects that the temperature in the hot water tank 9 is increased to reach a predetermined upper limit temperature, the heater 30 is turned off (steps S₂₂ and S₂₃).

If, for example, a bimetal switch is used as the temperature sensor 29, the temperature sensor 29 itself can turn on and off the heater 30. In this case, the lower limit temperature in step S₂₀ and the upper limit temperature in step S₂₂ are the same temperature (the temperature at which the bimetal switch turns on and off the heater 30). Although there may be a difference between the temperature of the outer wall surface of the hot water tank 9 (the temperature directly detected by the bimetal switch) and the temperature of the drinking water in the hot water tank 9, there is a correlation between these temperatures. For example, in cases where the temperature at which the bimetal switch turns on and off the heater 30 is 85 degrees Celsius, the temperature of the drinking water in the hot water tank 9 at the time point when the heater 30 is turned on may be about from normal temperature to 95 degrees Celsius. The temperature of the drinking water in the hot water tank 9 at the time point when the heater 30 is turned off is limited within a range of about from 85 to 95 degrees Celsius. If a sensor capable of directly detecting the temperature of the drinking water in the hot water tank 9 is used as the temperature sensor 29, it is possible to set the lower limit temperature in step S₂₀ and the upper limit temperature in step S₂₂ to different values.

During the sterilization operation, the above mentioned water level control is suspended. In other words, even if the water level in the cold water tank 2 falls below the lower limit water level set in the water level control while the sterilization operation is being carried out, drinking water is not pumped up from the raw water container 3 into the cold water tank 2. During the sterilization operation, the control device 41 performs a valve control configured to switch the valves so as to form a circulation route through which drinking water flowing out of the hot water tank 9 can be circulated through predetermined portions of a piping system back to the hot water tank 9; and a pump control configured to drive the pump 6 so as to circulate the drinking water in the hot water tank 9 through the circulation route; with the heater control optionally combined as required, while suspending the water level control. One execution of the sterilization operation is defined to be from the initiation of the valve control to form the circulation route for the sterilization, until the completion of the driving of the pump for a predetermined period of time in order to circulate the drinking water heated to the sterilization temperature or higher through the circulation route for carrying out the sterilization. In general, if hot water having a temperature of 85 degrees Celsius or higher is circulated for 10 minutes or longer, a sufficient sterilization effect can be expected.

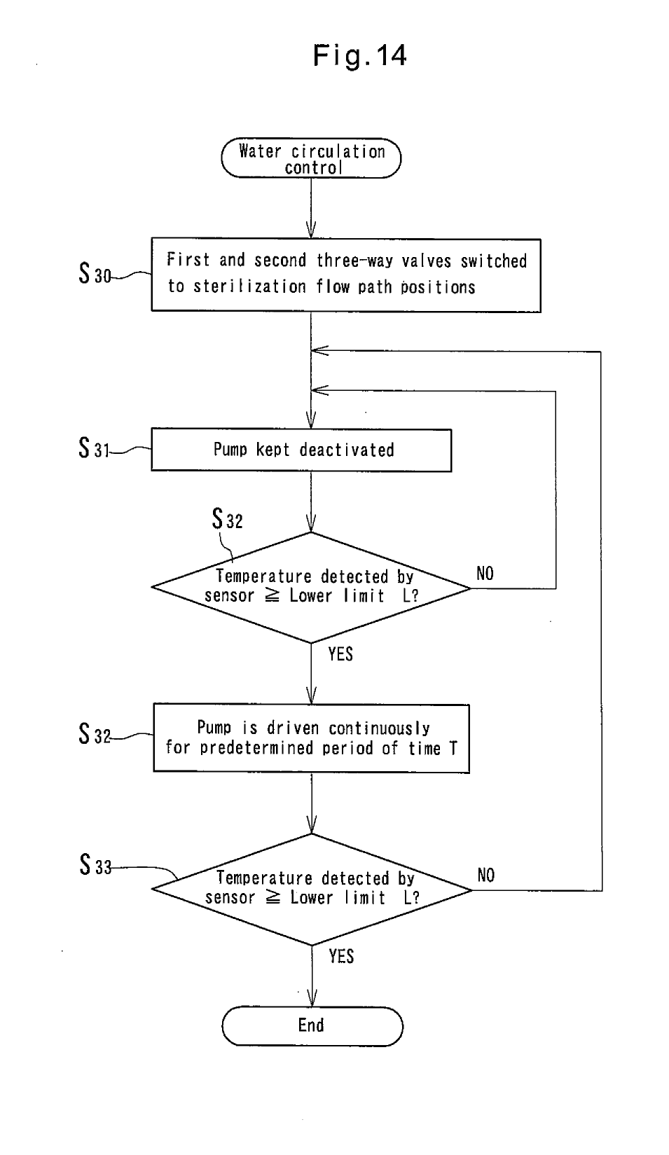

For example, the sterilization operation may consist of a preliminary water circulation control configured to raise the temperature of the circulating water; and a regular circulation control carried out thereafter to perform regular sterilization. The water circulation control is carried out, for example, according to the routine shown in FIG. 14. In this routine, first, the first three-way valve 13 and the second three-way valve 15 are switched to the respective sterilization flow path positions (step S₃₀). This arrangement allows to form, as shown in FIG. 2, the circulation route, through which high temperature drinking water in the hot water tank 9 is circulated passing through: the second sterilization pipe 16, the second three-way valve 15, the raw water pumping pipe 5, the first three-way valve 13, the first sterilization pipe 14, the buffer tank 7, and the hot water tank water supply pipe 10; sequentially. Next, the control device 41 performs a first operation in which the pump 6 is maintained in a deactivated state. In the first operation, while the temperature detected by the temperature sensor 29 is lower than a predetermined lower limit temperature L, the pump 6 is maintained in a deactivated state, until the temperature in the hot water tank 9 is increased to reach a predetermined high temperature due to the heater control (steps S₃₁ and S₃₂). The lower limit temperature L of the drinking water in the hot water tank 9 is set to a temperature higher than at least the lowest temperature at which the sterilization can be achieved (65 degrees Celsius).

In cases where a simple switch capable of outputting only two temperature signals corresponding, respectively, to on and off of the switch, such as a bimetal switch, is used as the temperature sensor 29 to carry out the above described heater control, it is preferred that the lower limit temperature L be the same temperature as the lower limit temperature set in the heater control (for example, 85 degrees Celsius). With this arrangement, it is possible to control the first operation of the pump 6 utilizing the two temperature signals of the temperature sensor 29 corresponding, respectively, to on and off of the sensor. In other words, since the temperature of the drinking water in the hot water tank 9 at the time point when the heater 30 is turned off is limited to a high temperature (for example, about from 85 to 95 degrees Celsius), as described above, if the answer in step S₃₂ is determined to be “Yes”, it is ensured that the temperature of the drinking water flowing out of the hot water tank 9 when the pump is turned on is at a high temperature.

When the temperature in the hot water tank 9 detected by the temperature sensor 29 is increased to reach the lower limit temperature L due to the heater control, a second operation (step S₃₃) is carried out in which the pump 6 is continuously driven for a predetermined period of time T. During the second operation (step S₃₃), since the drinking water in the circulation route (particularly the drinking water in the buffer tank 7, in this embodiment) is introduced into the hot water tank 9, the temperature in the hot water tank 9 falls. When, as a result, the temperature detected by the temperature sensor 29 falls below the lower limit temperature L, the heater 30 is turned on.

In this embodiment, the predetermined period of time T is determined to be the same as, or shorter than, the period of time required for the pump 6 to pump out the amount of drinking water equivalent to the capacity of the hot water tank 9. For example, if the capacity of the hot water tank 9 (its capacity to hold drinking water) is 1.2 liters, and the amount of drinking water the pump 6 pumps out per minute is 1 liter, the predetermined period of time T, which is the length of time during which the pump 6 is continuously driven in step S₃₃, is determined to be the same as the period of time required for the pump 6 to pump out 1.2 liters of drinking water (1 minute and 12 seconds), or a period of time shorter than that (for example, 1 minute).

Further, the predetermined period of time T is determined to be the same as, or longer than, the period of time required for the pump 6 to pump out the amount of drinking water equivalent to the capacity of the buffer tank 7. For example, if the capacity of the buffer tank 7 (its capacity to hold drinking water) is 0.3 liter, and the amount of drinking water the pump 6 pumps out per minute is 1 liter, the predetermined period of time T during which the pump 6 is continuously driven in step S₃₃ is determined to be the same as the period of time required for the pump 6 to pump out 0.3 liter of drinking water (18 seconds), or a period of time longer than that (for example, 1 minute).

The control device 41 determines, after carrying out the second operation (step S₃₃), whether or not the temperature in the hot water tank 9 detected by the temperature sensor 29 is equal to or higher than the lower limit temperature L (step S₃₄), and if it is, the first operation (steps S₃₁ and S₃₂) is carried out again. Thereafter, the first operation (steps S₃₁ and S₃₂) and the second operation (step S₃₃) are carried out alternately and repeatedly.

When the control device 41 determines, after carrying out the second operation (step S₃₃), that the temperature detected by the temperature sensor 29 is equal to or higher than the lower limit temperature L (step S₃₄), it is considered that the overall temperature of the drinking water in the circulation route 19 has been increased to reach the sterilization temperature, and thus, the repetitive alternate execution of the first and the second operations in the intermittent pump drive control is terminated. In this embodiment, the sterilization temperature is set to a temperature higher than the lowest temperature at which the sterilization can be achieved (65 degrees Celsius), and lower than the upper limit temperature set in the heater control.

When the above described water circulation control (FIG. 14) is completed, the regular circulation control is carried out. During the regular circulation control, the pump 6 is further driven continuously, while concurrently carrying out the heater control of the hot water tank 9. By carrying out the regular circulation control, the circulation route can be reliably sterilized with the high temperature drinking water heated to the sterilization temperature. At this time, a third operation may be carried out repeatedly in which the pump 6 is driven for a predetermined first period of time (for example, 2 minutes), and after every third operation, a fourth operation may be carried out in which the pump 6 is maintained in a deactivated state for a predetermined second period of time (for example, 2 minutes). This allows for reducing the total number of revolutions of the pump 6 required to circulate the high temperature drinking water heated to the sterilization temperature through the circulation route.

For example, it may be possible, during the sterilization operation, to continuously drive the pump 6 without stopping from the start until the end of the sterilization operation. However, if the pump 6 is driven in this manner, since the pump 6 keeps rotating without stop even while the temperature of the circulating drinking water has not yet been increased to the sterilization temperature, the total number of revolutions of the pump 6 required per sterilization operation increases. This could potentially cause the necessity to reduce the frequency of carrying out the sterilization operation, in order to secure a long service life of the pump 6 (for example, it may be necessary to extend the intervals between sterilization operations to e.g. a week or longer).

On the other hand, by carrying out the water circulation control shown in FIG. 14, in which the first operation in which the pump 6 is maintained in a deactivated state until the temperature of the drinking water in the water tank 9 is increased to the predetermined high temperature (steps S₃₁, S₃₂ and S₃₄) is carried out repeatedly, alternating with the second operation in which the pump 6 is continuously driven for the predetermined period of time (step S₃₃), the temperature of the drinking water in the hot water tank 9 is allowed to increase while the pump 6 is maintained in a deactivated state, and the pump 6 is driven only when the temperature in the hot water tank 9 is increased to the predetermined high temperature. This serves to reduce the total number of revolutions of the pump 6 required until the temperature of the circulating drinking water is increased to the sterilization temperature, thereby reducing the total number of revolutions of the pump 6 required per sterilization operation. Accordingly, even if the sterilization operation is carried out more frequently (for example, about once a day), it is possible to secure a long service life of the pump 6.

By determining the above mentioned predetermined period of time T to be the same as, or longer than, the period of time required for the pump 6 to pump out the amount of drinking water equivalent to the capacity of the buffer tank 7, the drinking water in the buffer tank 7 can be replaced with high temperature drinking water every time when the continuous drive of the pump 6 is carried out, and the temperature of the drinking water in the circulation route can be efficiently increased to the sterilization temperature.

In addition, the control device 41 drives the pump 6 such that the rotational speed of the pump 6 during the sterilization operation (in other words, in step S₃₃) is lower than the rotational speed of the pump 6 during the normal operation (in other words, in step S₁₁). This reduces the driving sound of the pump 6 during the sterilization operation mode, and ensures quiet sterilization operation, which is expected to be carried out late at night.

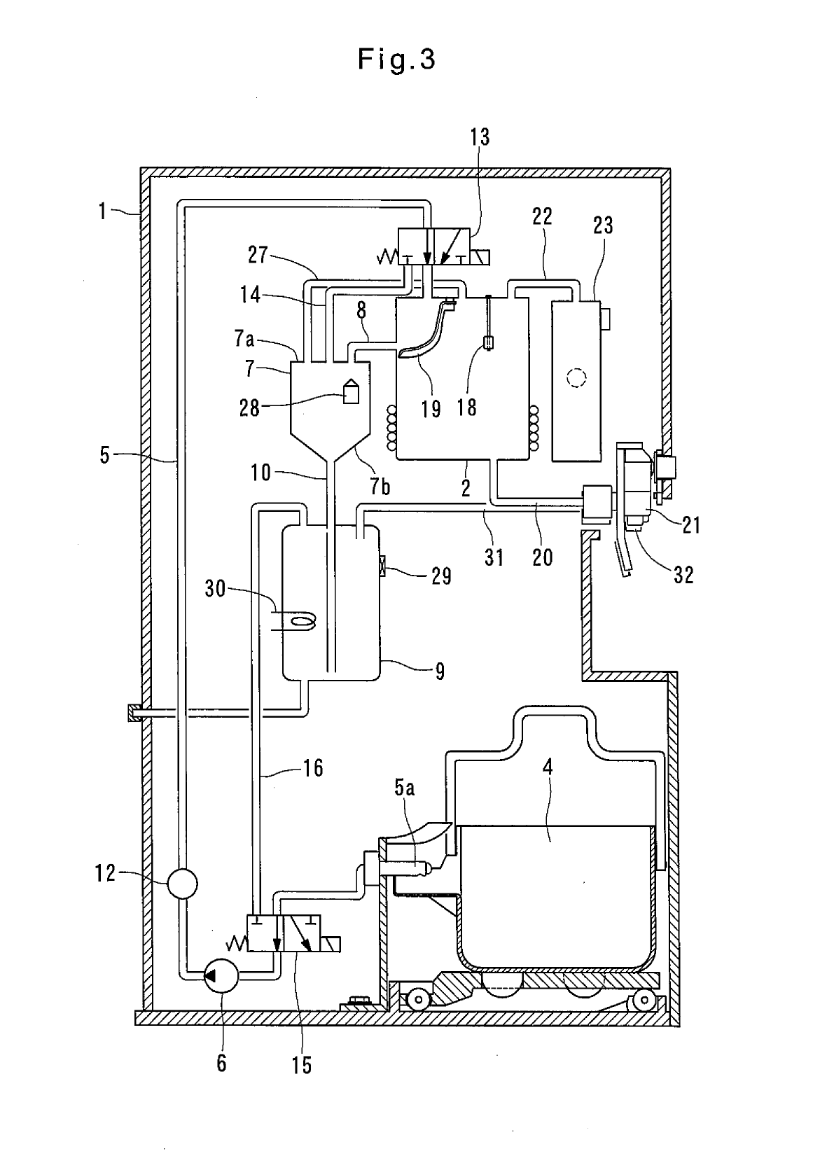

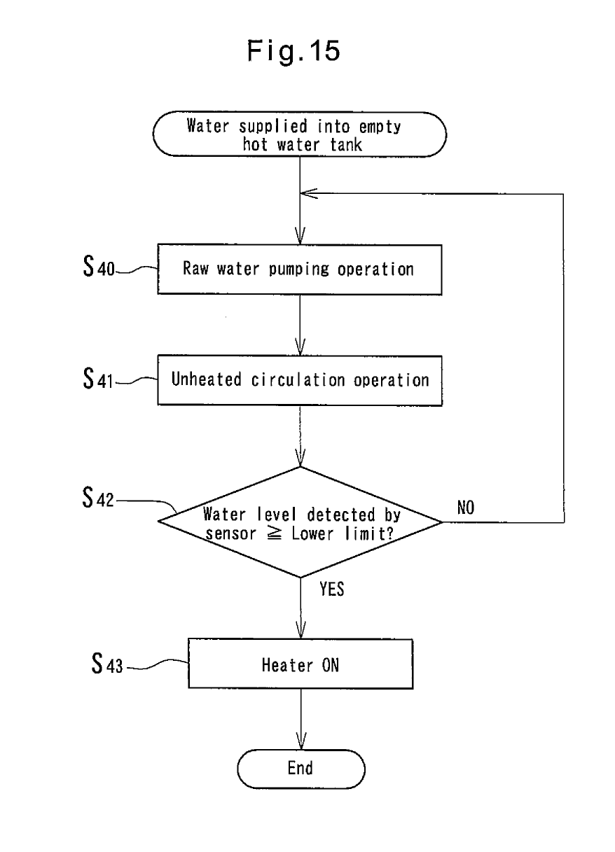

In the above mentioned water dispenser, when supplying drinking water to the hot water tank 9 with the hot water tank 9 empty as shown in FIG. 3 (such as when introducing drinking water to a brand-new water dispenser for the first time, or when reintroducing drinking water into an already installed water dispenser after drinking water has been drained for maintenance), in order to prevent the heater 30 from being turned on (and thus heating the hot water tank 9) while the hot water tank 9 is still empty, a raw water pumping operation (step S₄₀) is carried out alternately with an unheated circulation operation (step S₄₁) , as shown in FIG. 15.

Specifically, when drinking water is introduced into the hot water tank 9 with the hot water tank 9 empty as shown in FIG. 3, the same amount of air as the amount of drinking water to be introduced into the hot water tank 9 needs to be discharged from the hot water tank 9. If air is not discharged smoothly from the hot water tank 9, drinking water cannot be introduced into the hot water tank 9 from the buffer tank 7. If the heater 30 is turned on in this state, the hot water tank 9 is heated with no water in it. Once this happens, when the hot water tank 9 is filled with drinking water thereafter, the drinking water may smell and/or taste bad.

Therefore, in this water dispenser, when drinking water is introduced into the empty hot water tank 9, the raw water pumping operation (step S₄₀) and the unheated circulation operation (step S₄₁) shown in FIG. 15 are carried out alternately with each other. These operations are carried out, for example, immediately before carrying out the water level control for the first time, after the water dispenser is turned on.

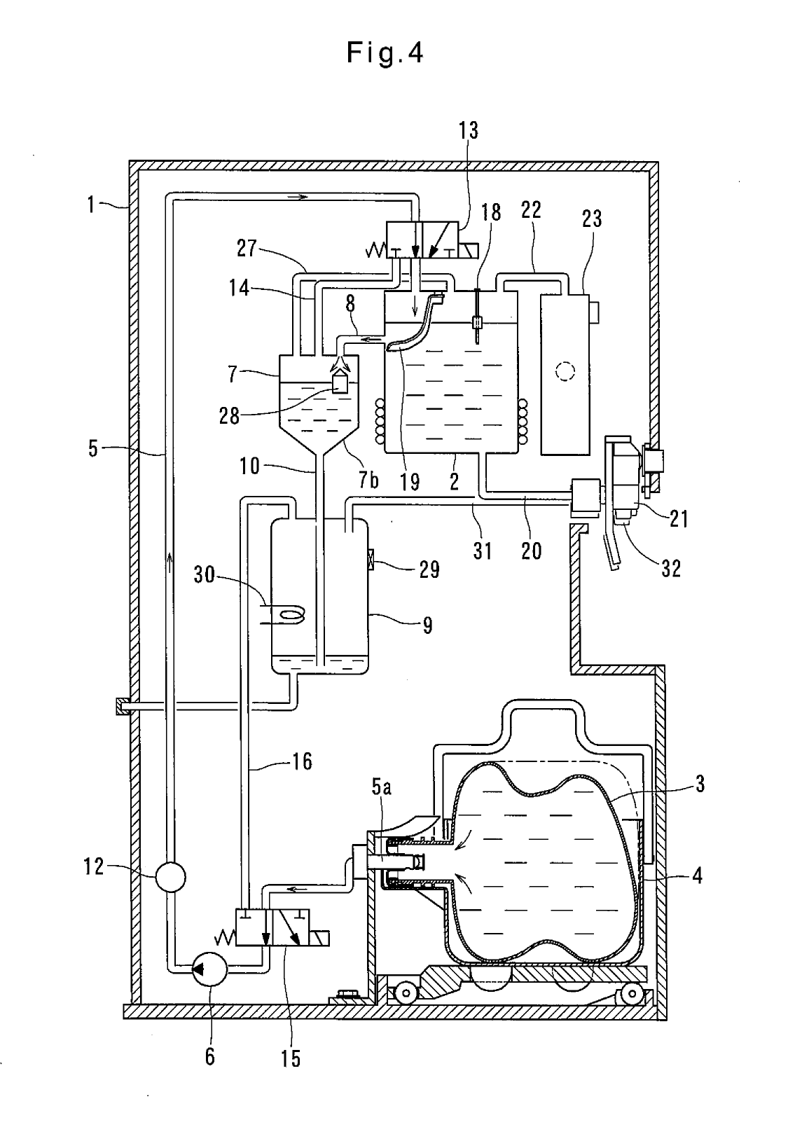

During the raw water pumping operation (step S₄₀), the water level control shown in FIG. 12 is carried out while the heater 30 is maintained off, with the first three-way valve 13 and the second three-way valve 15 switched to the respective normal flow path positions, as shown in FIG. 4. During the raw water pumping operation, since drinking water is pumped up from the raw water container 3 into the cold water tank 2 to increase the water level in the cold water tank 2, drinking water in the cold water tank 2 is introduced into the buffer tank 7 through the buffer tank water supply pipe 8. When the water level in the cold water tank 2 rises to the upper limit water level or higher (step S₁₂) and the pump 6 is deactivated (step S₁₄), the control device 41 shifts to executing the unheated circulation operation (step S₄₁).

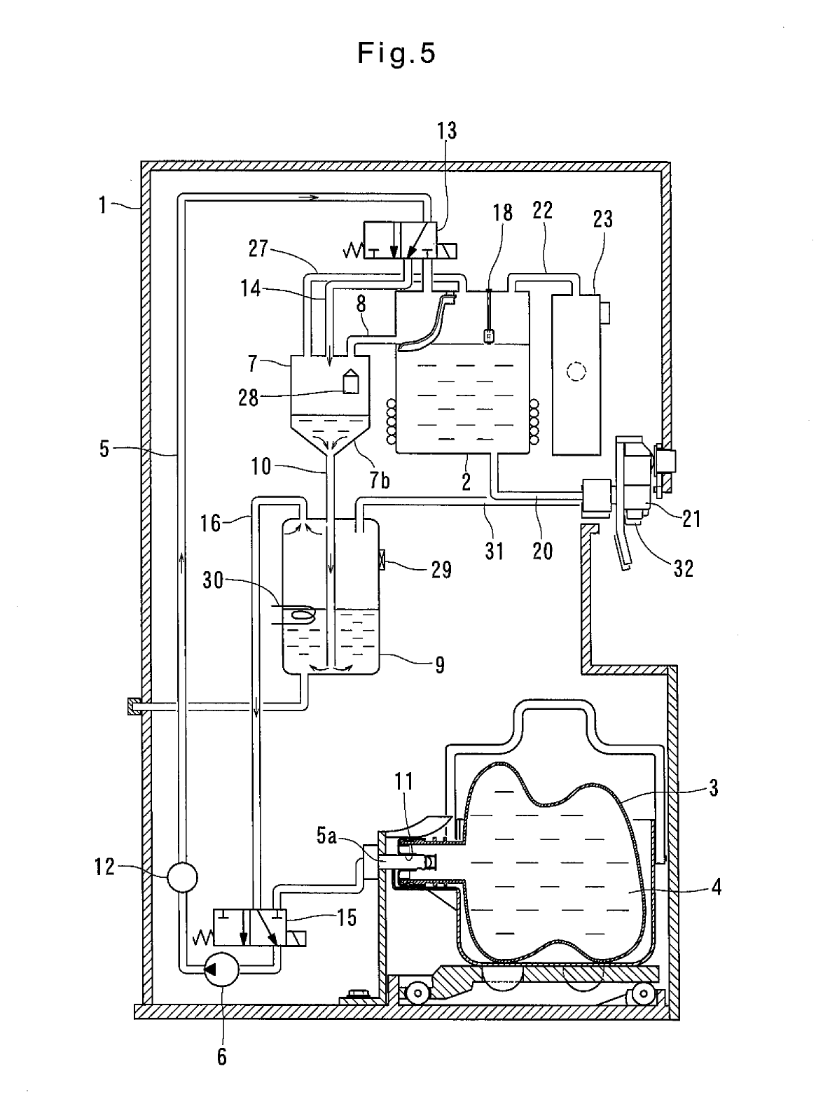

During the unheated circulation operation (step S₄₁) shown in FIG. 15, the pump 6 is driven for a predetermined period of time while the heater 30 is maintained off, with the first three-way valve 13 and the second three-way valve 15 switched to the respective sterilization flow path positions, as shown in FIG. 5. During the unheated circulation operation, since air accumulated in the upper portion of the hot water tank 9 is discharged through the second sterilization pipe 16, at least the same amount of drinking water as the amount of the discharged air is transferred from the buffer tank 7 to the hot water tank 9.

As described above, pumping up of drinking water executed in the raw water pumping operation (step S₄₀) and transfer of drinking water from the buffer tank 7 to the hot water tank 9 executed in the unheated circulation operation (step S₄₁) are carried out alternately with each other, and as a result, introduction of drinking water to the hot water tank 9 can be reliably carried out, and the situation in which the heater 30 is turned on when there is no water in the hot water tank 9 can be prevented.

Further, the control device 41 determines whether or not the water level in the cold water tank 2 immediately after the execution of the unheated circulation operation is equal to or higher than the lower limit water level set in the water level control (step S₄₂), and if it is determined that the water level is equal to or higher than the lower limit water level, the heater 30 is turned on (step S₄₃). With this arrangement, it is possible to turn on the heater 30 automatically only when there is no risk that the hot water tank 9 is heated with no water in it.

Thereafter, the control device 41 shifts to the controls which are carried out during the normal operation mode. At this time, the water dispenser is in a state where drinking water has been introduced to the hot water tank 9, the buffer tank 7 and the cold water tank 2, as shown in FIG. 1.

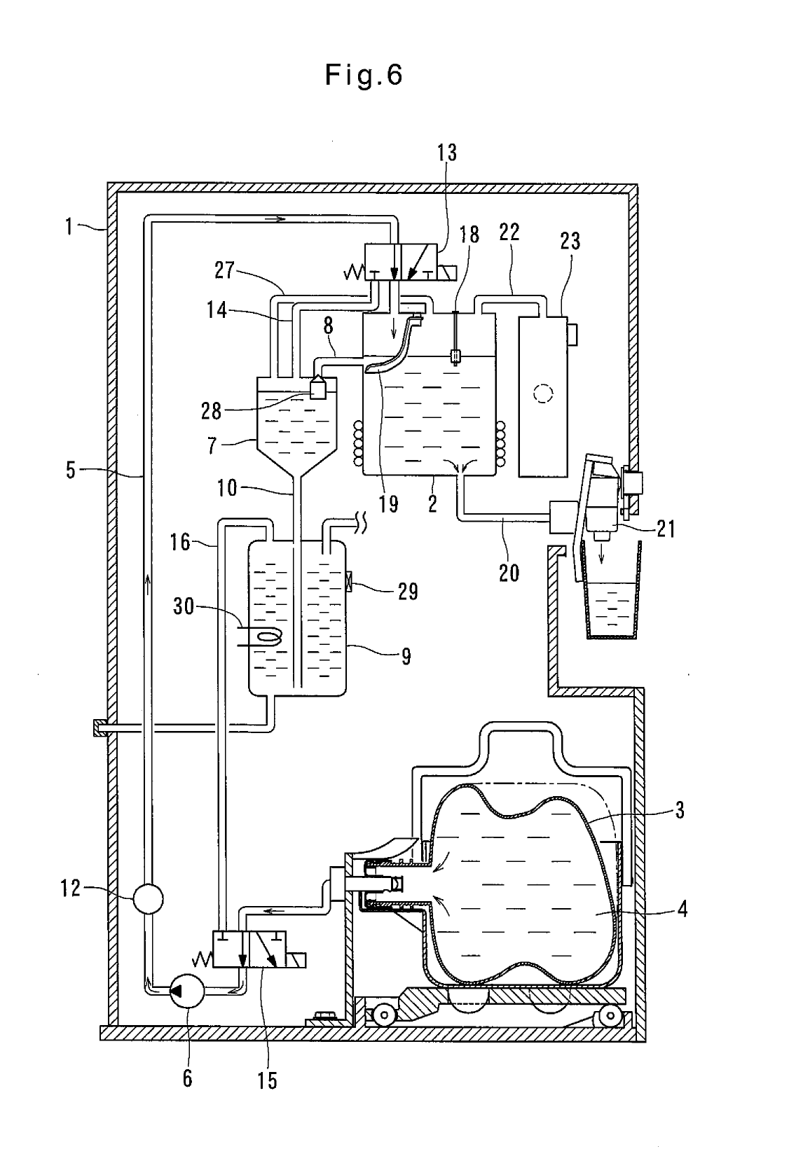

As shown in FIG. 6, when the cold water cock 21 is operated, low temperature drinking water in the cold water tank 2 is discharged to the outside through the cold water discharging pipe 20, due to its own weight. As the water is discharged, the drinking water in the cold water tank 2 is decreased. When the water level in the cold water tank 2 detected by the water level sensor 18 falls below the lower limit water level, the pump 6 is driven according to the above mentioned water level control, and drinking water in the raw water container 3 is pumped up to the cold water tank 2 through the raw water pumping pipe 5. At this time, since the flow of drinking water from the raw water pumping pipe into the cold water tank 2 is changed in a horizontal direction by the guide plate 19, the cold water accumulated in the lower portion of the cold water tank 2 is less likely to be stirred by the drinking water flowing in. As a result, drinking water in the cold water tank 2 can be cooled effectively.

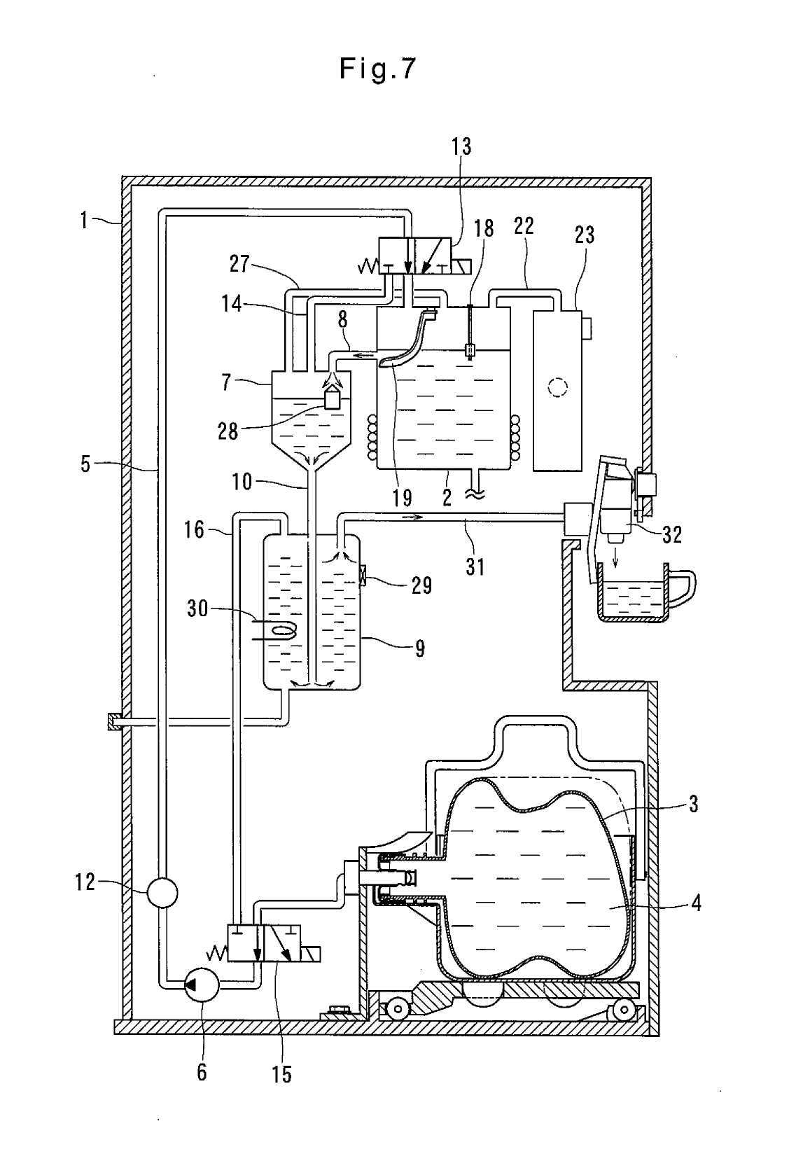

Further as shown in FIG. 7, when the hot water cock 32 is operated, high temperature drinking water in the hot water tank 9 is discharged to the outside through the hot water discharging pipe 31. At this time, drinking water in the buffer tank 7 is introduced into the hot water tank 9 through the hot water tank water supply pipe 10, due to its own weight. Drinking water in the buffer tank 7 plays a role to push out drinking water in the hot water tank 9 to the outside. As drinking water in the buffer tank 7 is introduced into the hot water tank 9, the water level in the buffer tank 7 falls. This causes the float valve 28 to open, thereby allowing the drinking water forming the upper layer portion of the drinking water in the cold water tank 2 to be introduced into the buffer tank 7 through the buffer tank water supply pipe 8.

At this time, as shown in FIGS. 9 (a) and (b), since the flow of the drinking water from the raw water pumping pipe 5 into the cold water tank 2 is redirected to the flow toward the buffer tank water supply pipe 8 by the guide plate 19, most of the drinking water introduced from the raw water pumping pipe 5 into the cold water tank 2 is immediately discharged from the cold water tank 2 through the buffer tank water supply pipe 8. As a result, drinking water in the cold water tank 2 can be effectively maintained at a low temperature.

As drinking water is introduced from the buffer tank 7 into the hot water tank 9, the temperature of the drinking water in the hot water tank 9 falls. When the temperature in the hot water tank 9 detected by the temperature sensor 29 falls below the lower limit temperature (for example, 85 degrees Celsius) set in the heater control, the heater 30 is turned on to heat the drinking water in the hot water tank 9.

When drinking water in the hot water tank 9 is heated by the heater 30, there are cases where air dissolved in the drinking water is separated from the water in the form of air bubbles as the temperature of the drinking water is increased, and the air bubbles ascend inside the hot water tank 9 and accumulate in the upper portion of the hot water tank 9 to form an air layer, as shown in FIG. 10.

Therefore, in this water dispenser, in order to prevent air accumulated in the hot water tank 9 from blowing out through the hot water discharging pipe 31 when a user discharges drinking water in the hot water tank 9, the end portion 31a of the hot water discharging pipe 31 on the side of the hot water tank 9 has an opening at a position spaced apart from the upper surface 9a of the hot water tank 9, as described above,. With this arrangement, the air accumulated in the hot water tank 9 along its upper surface 9a is less likely to be introduced into the hot water discharging pipe 31.

Further, as shown in FIG. 10, when the amount of air accumulated in the hot water tank 9 is increased, air in the hot water tank 9 is discharged via the small hole 34 provided in the in-tank pipe portion 33 of the hot water tank water supply pipe 10. Therefore, there is no possibility that air is accumulated in the portion of the hot water tank 9 below the small hole 34. Since the small hole 34 opens at a position higher than the opening of the end portion 31a of the hot water discharging pipe 31 on the side of the hot water tank 9, it is possible to effectively prevent the situation in which air in the hot water tank 9 is introduced into the hot water discharging pipe 31.

In addition, since the end portion 16a of the second sterilization pipe 16 on the side of the hot water tank 9 opens at a position higher than the position of the small hole 34 in the in-tank pipe portion 33 of the hot water tank water supply pipe 10, air accumulated in the hot water tank 9 along its upper surface 9a is discharged from the hot water tank 9 through the second sterilization pipe 16 during the sterilization operation mode. Accordingly, when a user discharges high temperature drinking water in the hot water tank 9, it is possible to reliably prevent high temperature air from blowing out through the hot water discharging pipe 31.

During the sterilization operation, as shown in FIG. 2, high temperature drinking water in the hot water tank 9 is circulated through the second sterilization pipe 16, the second three-way valve 15, the raw water pumping pipe, the first three-way valve 13, the first sterilization pipe 14, the buffer tank 7, and the hot water tank water supply pipe 10, in this order, to sterilize the circulation route. At this time, high temperature drinking water does not pass through the cold water tank 2. Therefore, a user is able to discharge low temperature drinking water in the cold water tank 2, even during the sterilization operation.

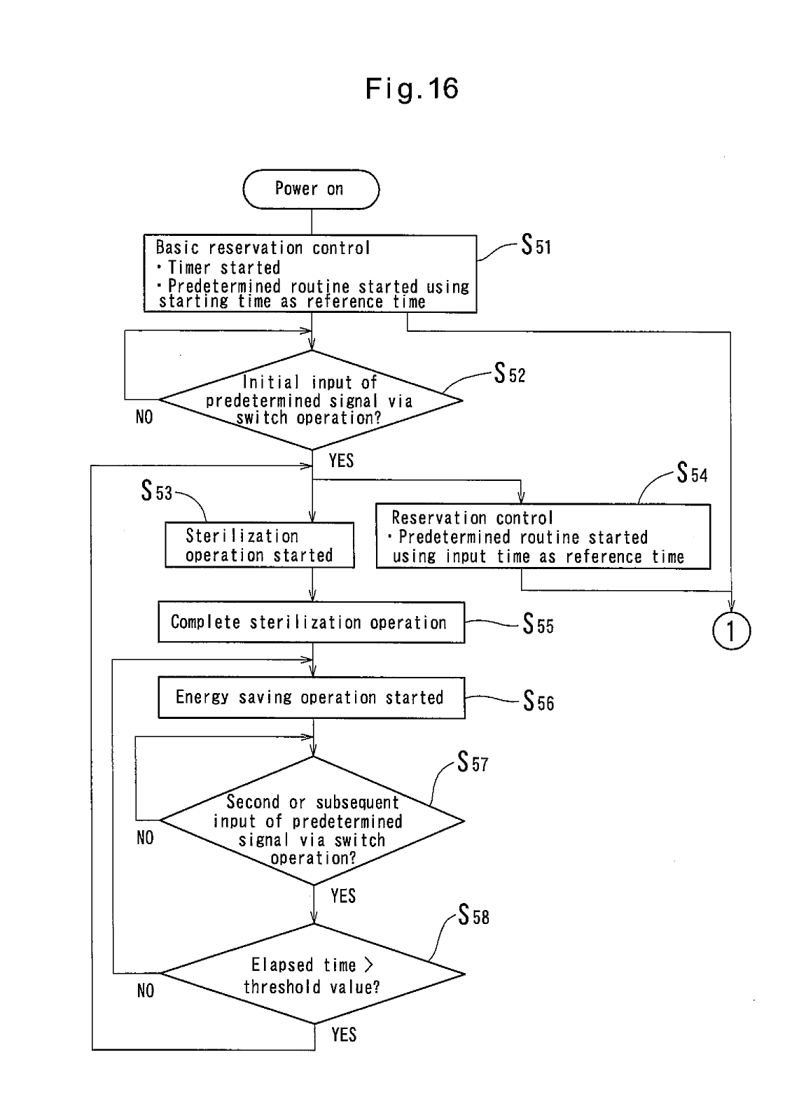

Now, the timings at which individual segments of the sterilization operation start will be described in detail. First, as shown FIG. 16, when the control device 41 is turned on, the control device 41 carries out a basic reservation control (step S₅₁) in which a timer control of the individual sterilization operation segments starts automatically according to a predetermined routine. In the basic reservation control, the timer starts when the power is turned on, and the predetermined routine begins based on a reference time. The time when the timer started is stored in the control device 41.

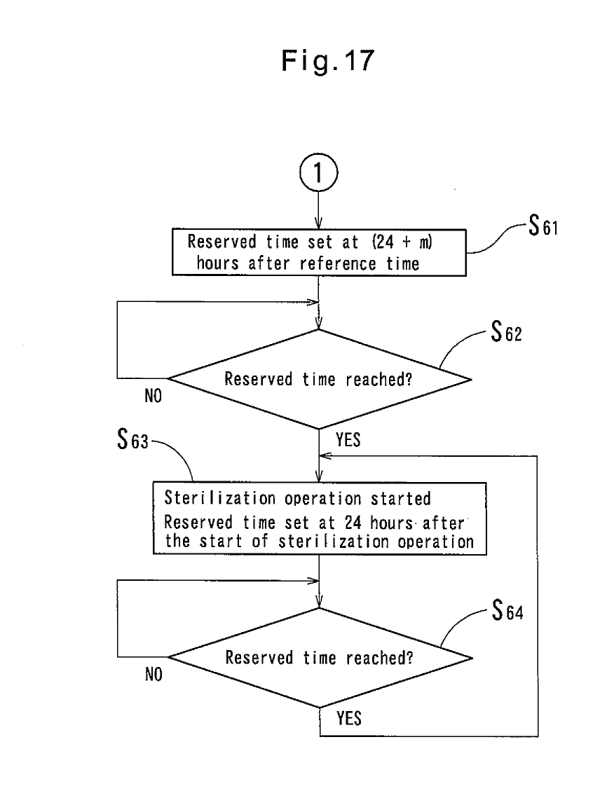

As shown in FIG. 17, in the predetermined routine, the reserved time for carrying out the initial sterilization operation segment is set at a time which is later than 24 hours after the reference time determined in step S₅₁, by a specified period of time: m (step S₆₁). In this embodiment, the specified period of time: m is determined to be 2 hours.

Next, the control device 41 monitors the elapse of time by the timer, until (24+m) hours pass (step S₆₂) since the reference time. At the reserved time, the control device 41 starts the initial sterilization operation segment, and determines the reserved time for carrying out the second sterilization operation segment (step S₆₃). The control device 41 determines the reserved times of the second and following sterilization operation segments such that each of the reserved times is set at a time which is 24 hours after the last reserved time (steps S₆₄ and S₆₃).

As shown in FIG. 16, if, after the basic reservation control is started (step S₅₁), a user operates the switch 42 in a predetermined manner, and as a result, a predetermined signal is input to the control device 41, and if this predetermined signal is the first input after the water dispenser is turned on (step S₅₂), the control device 41 starts a sterilization operation segment (step S₅₃). Every time when the above described predetermined signal is input to the control device 41, the control device 41 obtains the time of the input from the timer. Hereinafter, the times at which the predetermined signal is input to the control device 41 (the times obtained from the timer) are simply referred to as “input times”. Further, the input time obtained in step S₅₂ is simply referred to as “the initial input time”. Of these input times, which are the times when the predetermined signal is input which causes the individual sterilization operation segments to be started, at least the input time corresponding to the last sterilization operation segment is stored in the control device 41.

If step S₅₂ is actually carried out, the control device 41 carries out reservation control to update the reserved times for carrying out the individual sterilization operation segments determined by the timer control, according to the above predetermined routine but based on the initial input time (step S₅₄). In the reservation control, the control device 41 clears the reserved times for carrying out the sterilization operation segments determined in the basic reservation control, and determines new reserved times for carrying out the sterilization operation segments according to the predetermined routine shown in FIG. 17. Therefore, the next(first) reserved time for carrying out the next (first) sterilization operation segment is updated to a time which is (24+m) hours after the initial input time (step S₆₁), that is, 26 hours after the initial input time. Further, each of the reserved times for carrying out the “n-th” (n is a natural number equal to or greater than 2) sterilization operation segments following the above first reserved time is set at a time which is (24+m+24n) hours after the initial input time (steps S₆₂ to S₆₄).

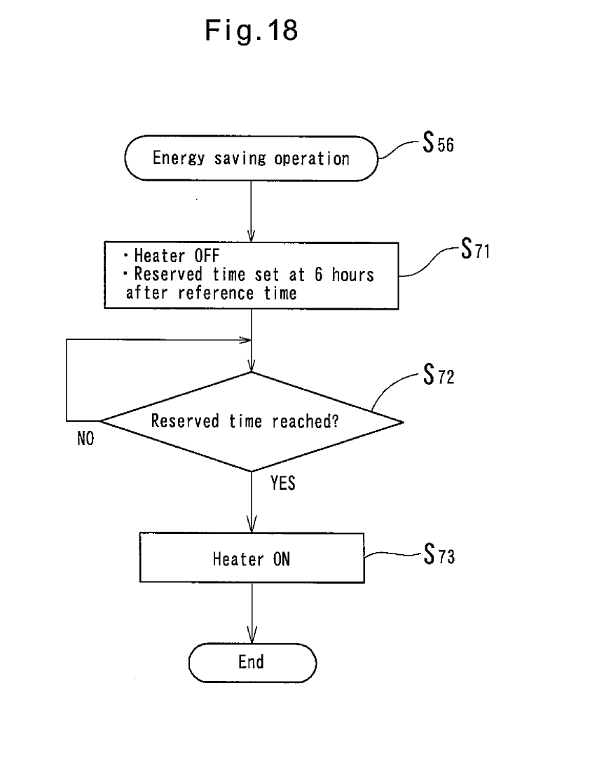

As shown in FIG. 16, when the sterilization operation segment started at step S₅₃ is completed (step S₅₅), the control device 41 starts the energy saving operation (step S₅₆). FIG. 18 illustrates how the energy saving operation is operated in detail.

As shown in FIG. 18, the control device 41 maintains the heater 30 off, and sets a reserved time for turning on the heater 30 to a time which is later than the last input time by a prescribed period of time (step S₇₁). If the heater 30 is on at the time point when the last sterilization operation segment is completed and step S₇₁ is started, the control device 41 turns off the heater 30. In this embodiment, the prescribed period of time is determined to be 6 hours. Next, the control device 41 monitors the elapse of time by the timer, until the prescribed period of time passes since the input time (step S₇₂). When the reserved time is reached, the control device 41 turns on the heater 30 (step S₇₃).

As shown in FIG. 16, after the execution of step S₅₆, if the input of the second or subsequent predetermined signal after the power is turned on is confirmed (step S₅₇), the control device 41 compares the elapsed time since the input which initiated the last sterilization operation segment with a threshold value (step S₅₈), in which the elapsed time is the difference between the input time which initiated the last sterilization operation segment and the current input time. If the current input time is the second input of the predetermined signal after the power is turned on, the input time which initiated the last sterilization operation segment is the initial input time.

In this embodiment, the threshold value is determined to be 14 hours.

If the relation: elapsed time>threshold value is satisfied in step S₅₈, steps S₅₃ and S₅₄ are executed again. In other words, if the second or subsequent input of the above mentioned predetermined signal is confirmed after the power is turned on, and if the relation: elapsed time>threshold value is satisfied, the control device 41 carries out the sterilization operation segment in step S₅₃, the energy saving operation (steps S₅₆, and S₇₁ to S₇₃), and the reservation control (steps S₅₄, and S₆₁ to S₆₄). As a result, new reserved times for carrying out the individual sterilization operation segments are determined again according to the predetermined routine shown in FIG. 17, based on the input time obtained in step S₅₇ which satisfies the relation: elapsed time>threshold value, and the existing reserved times for the sterilization operation segments are cleared. Thus, next (first) reserved time for carrying out the next (first) sterilization operation segment is updated to a time which is (24+m) hours after the second or subsequent input time obtained in step S₅₇ (step S₆₁). Further, each of the reserved times for the “n-th” sterilization operation segment is set at a time which is (24+m+24n) hours after the second or subsequent input time obtained in step S₅₇ (steps S₆₂ to S₆₄). The control device 41 is configured to store the input time obtained in step S₅₇ as the input time which initiated the last sterilization operation segment. For example, in cases where the input corresponds to the second input after the power is turned on, the initial input time is stored in the control device 41 as the input time which initiated the last sterilization operation segment. If the elapsed time since the first input time until the second input time is greater than the threshold value, the second sterilization operation segment is carried out, and thus the second input time is stored as the input time which initiated the last sterilization operation segment.

On the other hand, if the relation: elapsed time≦threshold value is satisfied in step S₅₈, step S₅₆ is carried out again. In other words, the control device 41 carries out the energy saving operation (steps S₅₆ and S₇₁ to S₇₃) without carrying out the sterilization operation and the reservation control. For example, in cases where the input corresponds to the second input after the power is turned on, if the elapsed time since the initial input time until the second input time is not greater than the threshold value, the sterilization operation is not carried out, and thus, the second input time is not recognized as the input time which initiated the last sterilization operation segment.

When the power is turned off, all the reserved times determined by the timer control stored in the control device 41 are deleted. The control device 41 executes the procedures following step S₅₁ in FIG. 16, every time when the power is turned on.

As described above, since this water dispenser is configured such that the basic reservation control (step S₅₁), in which the timer control of the sterilization operation automatically starts according to the predetermined routine (steps S₆₁ to S₆₃), is carried out when the power is turned on, it is possible, once the power of the water dispenser is turned on, to carry out the sterilization operation (step S₆₃) at intervals (steps S₆₂ and S₆₄) determined by the manufacturer of the water dispenser to be sufficient to ensure at least minimum requirements for sanitation of the water dispenser.

Further, since this water dispenser is configured such that the sterilization operation (step S₅₃) can be carried out at timings when a user operates the switch 42 to start the energy saving operation (steps S₅₂ and S₅₇), the sterilization operation can be carried out at timings suited to the daily life cycle of the user (steps S₅₂ and S₅₇). Since the energy saving operation (step S₅₆) is carried out after the sterilization operation is completed (step S₅₅), it is possible to maintain the temperature of the drinking water to be circulated during the sterilization operation (steps S₅₃ and S₅₅) to a temperature appropriate for carrying out the sterilization. In other words, since the opportunities for the user to employ the energy saving operation (step S₅₆) based on the daily life cycle of the user, that is, the period of time during which the user is in bed and/or the period of time during which the user is regularly away from home (steps S₅₂ and S₅₇), are expected to occur virtually every day, the opportunities to carry out the sterilization operation (step S₅₃) at the timing when the user utilizes the energy saving operation depending on his/her daily life cycle (steps S₅₂ and S₅₇) are also expected to occur frequently. Therefore, it is possible to repeatedly reschedule the reserved time for carrying out the sterilization operation determined by the timer control (step S₆₃) by the reservation control (steps S₅₄, and S₆₁ to S₆₃), and to carry out the sterilization operation (step S₅₃) at the timings suited to the daily life cycle of the user (steps S₅₂ and S₅₇).

Further, in this water dispenser, even if the energy saving operation (step S₅₆) is employed twice every day, at the time at which the user goes to bed and at which the user leaves home regularly (steps S₅₂ and S₅₇), the continuous execution (steps S₅₃ to S₅₆) of the sterilization operation and the energy saving operation is initiated only in cases where the condition in step S₅₈ is satisfied based on the threshold value: 14 hours, when the user employs the energy saving operation. With this arrangement, by presetting an adequate threshold value determined by the manufacture, the sterilization operation (step S₅₃) can be carried out repeatedly at the timings suited to the daily life cycle of the user (steps S₅₇ and S₅₈), while avoiding the situation where the sterilization operation (step S₅₃) is carried out excessively. At the same time, it is possible to continuously ensure that the sterilization operation (step S₆₃) is carried out at appropriate intervals according to the predetermined routine (steps S₆₁ to S₆₄) such that the sanitation of the water dispenser is maintained, while repeatedly rescheduling the reserved time determined by the timer control for carrying out the sterilization operation (step S₆₃).

In addition, in this water dispenser, it is possible to ensure that the sterilization operation is carry out once every day at the same time (steps S₆₂ to ^{S}₆₄), except for the first reserved time, regardless of whether the reserved time for the sterilization operation is determined in the basic reservation control (steps S₅₁, and S₆₁ to S₆₄) or in the reservation control (steps S₅₄, and S₆₁ to S₆₄).

Since the specified period of time: m is determined to be 2 hours or less in this water dispenser, it is possible to secure the execution of the sterilization operation, in general, once every day at the same time (steps S₆₁ and ₆₃), without having the concern that the next reserved time (step S₆₁) determined in the reservation control (step S₅₄, and S₆₁ to S₆₄) may not be suited to the daily life cycle of the user.

Further, since the specified period of time: m is determined to be 2 hours or less in this water dispenser, even if the actual time at which the energy saving operation is employed (corresponds to the input time obtained in S₅₂ or S₅₇) happens to be inconsistent with the regular daily life cycle of the user, the reserved times (steps S₆₁ and S₆₃) to be determined in the reservation control (steps S₅₄, and S₆₁ to S₆₄) for the next time onwards can be adjusted to better suit the daily life cycle of the user. Particularly, since the specified period of time: m is determined to be 2 hours or less, even if the actual time to employ the energy saving operation shifts within the range of one hour before and after the regular daily life cycle of the user, each of the reserved times (steps s₆₁ and S₆₃) can be adjusted to better suit the daily life cycle of the user.

Since, in this water dispenser, when the energy saving operation is employed, the heater 30 is turned on when the prescribed period of time: 6 hours has elapsed since the input time, it is possible to re-heat the drinking water in the hot water tank sufficiently before it is time for the user to wake up or to come home, corresponding to the average length of the period of time during which the user is in bed or the period of time during which the user is regularly away from home.

For example, if the power of the water dispenser was turned on at 12:00, on the day of installation, the reserved time for carrying out the sterilization operation is determined, as a result of the basic reservation control, at 14:00 (i.e., at the time which is 26 hours after the start of the timer) on the second day after the power-on, that is, the day following the first day at which the power of the water dispenser is turned on. If the energy saving operation is not employed until 14:00 on the second day after the power-on, the sterilization operation reserved by the timer is carried out. Therefore, during the period after the power is turned on until the first energy saving operation is employed, it is ensured that the sterilization operation reserved by the timer is carried out once every day starting at 14:00, except for the first day at which the power is turned on.

For example, in cases where the first energy saving operation after the power-on is employed at 23:00 on the first day at which the power is turned on, when the user goes to bed, the first sterilization operation after the power-on on is carried out from 23:00 on the first day at which the power is turned on. Further, as a result of the reservation control, the reserved time for carrying out the second sterilization operation after the power-on is updated to 1:00 on the third day after the power-on (i.e., the time (24+m) hours after 23:00 on the first day the power is turned on). Each of the reserved times for carrying out the sterilization for the third time onwards after the power-on is set once every day at 1:00, from the fourth day onwards after the power-on (i.e., at the time (24+m+24n) hours after 23:00 on the first day the power is turned on). In other words, the sterilization operation reserved by the timer at 14:00 on the second day after the power-on is not carried out, and thereafter, it is ensured by the timer control that the sterilization operation is carried out once every day starting at 1:00, from the third day onwards after the power-on. If the user usually goes to bet at 22:30, it can be considered that the user happens to go to bed at 23:00 on the first day the power is turned on, which is later than the regular time according to the daily life cycle, because of viewing a particular late-night program or the like. However, even if the sterilization operation reserved by the timer is initiated at 1:00, it is still carried out during the period of time while the user is in bed, and causes no problem.

For example, if the second energy saving operation after the power-on is employed at 8:00 on the second day after the power-on, thereafter, which is the time at which the user regularly leaves home, the relationship between the elapsed time (9 hours) and the threshold value (14 hours) satisfies the relation: elapsed time≦threshold value. Therefore the reservation control and the sterilization operation are not carried out, and the existing reserved time for the sterilization operation is maintained as it is, and the energy saving operation is carried out.

Thereafter, if the third energy saving operation after the power-on is employed at 22:30 on the second day after the power-on, at the time when the user goes to bed, for example, the relationship between the elapsed time (23 hours and 30 minutes) and the threshold value (14 hours) satisfies the relation: elapsed time>threshold value, and thus the sterilization operation, the reservation control and the energy saving operation are carried out again. As a result, the second reserved time of the sterilization operation after the power-on is determined at 0:30 on the fourth day after the power-on (i.e., the time which is (24+m) hours after 22:30 on the second day after the power-on), and each of the reserved times of the sterilization operation for the third time onwards after the power-on is set once every day at 0:30 from the fifth day onwards after the power-on (i.e., at the time which is (24+m+24n) hours after 22:30 on the second day after the power-on). In other words, the sterilization operation reserved by the timer at 1:00 on the third day after the installation is not carried out, and thereafter, it is ensured by the timer control that the sterilization operation is carried out once every day starting at 0:30 from the fourth day onwards after the power-on.

Since, in this water dispenser, the air layer in the buffer tank 7 serves as an insulation layer between the hot water tank 9 and the cold water tank 2, there is no risk that high temperature drinking water in the hot water tank 9 could be introduced into low temperature drinking water in the cold water tank 2. In other words, by disposing the buffer tank 7 between the cold water tank 2 and the hot water tank 9, drinking water which serves to push the drinking water in the hot water tank 9 to the outside and low temperature drinking water in the cold water tank 2 are kept separated. Further, since the float valve 28 is provided at the end portion of the buffer tank water supply pipe 8 on the side of the buffer tank 7, flowing back of the drinking water from the buffer tank 7 into the cold water tank 2 is reliably prevented. This allows for maintaining the drinking water in the cold water tank 2 at a low temperature, thereby preventing the proliferation of bacteria in the cold water tank 2.

In this water dispenser, by driving the pump 6 with both the first three-way valve 13 and the second three-way valve 15 switched to the respective sterilization flow path positions, it is possible to introduce high temperature drinking water in the hot water tank 9 into the raw water pumping pipe 5 and the buffer tank 7, thereby sterilizing the raw water pumping pipe 5 and the buffer tank 7. Further, since the water level control is suspended during the sterilization operation, even if low temperature drinking water in the cold water tank 2 is discharged to the outside by a user and the water level in the cold water tank 2 falls, the situation in which high temperature drinking water circulating through the raw water pumping pipe 5 is introduced into the cold water tank 2 can be prevented, and the drinking water in the cold water tank 2 can be maintained at a low temperature.

This water dispenser is excellent in terms of sanitation, since it is possible not only to prevent the proliferation of bacteria in the cold water tank 2 by maintaining the drinking water in the cold water tank 2 at a low temperature, but also to sterilize the raw water pumping pipe 5 and the buffer tank 7, which come in contact with relatively high temperature drinking water pumped out from the raw water container 3, with high temperature drinking water. In addition, since the high temperature drinking water does not pass through the cold water tank 2 when the raw water pumping pipe 5 and the buffer tank 7 are sterilized with high temperature drinking water in the hot water tank 9, low temperature drinking water in the cold water tank 2 is available to the user even during the sterilization operation.

The present invention is not limited to a water dispenser in which the raw water container is housed in the lower portion of the housing, and the present invention is also applicable to a water dispenser in which the raw water container is disposed on the floor outside the housing or the like, and drinking water therein is pumped up by a pump through a hose connected to the raw water container, and to a water dispenser in which the raw water container is disposed in the upper portion of the housing, as one disclosed in Patent Document 1.

### DESCRIPTION OF SYMBOLS

2 cold water tank
3 raw water container
5 raw water pumping pipe
6 pump
7 buffer tank
8 buffer tank water supply pipe
9 hot water tank
9a upper surface
10 hot water tank water supply pipe
13 first three-way valve
14 first sterilization pipe
15 second three-way valve
16 second sterilization pipe
16a end portion
28 float valve
30 heater
31 hot water discharging pipe
31a end portion
41 control device

1. A water dispenser comprising:
a hot water tank configured to store high temperature drinking water to be discharged to outside of the water dispenser;
a heater configured to heat drinking water in the hot water tank transferred from a replaceable raw water container; and
a control device configured to carry out a sterilization operation in which:
a valve control configured to switch valves so as to form a circulation route through which drinking water flowing out of the hot water tank can be circulated through predetermined portions of a piping system back to the hot water tank; and
a pump control configured to drive a pump so as to circulate the drinking water in the hot water tank through the circulation route; are combined,
wherein the control device is configured, when the water dispenser is turned on, to carry out a basic reservation control configured to automatically start a timer control of the sterilization operation according to a predetermined routine; and
if an input of a predetermined signal via a switch operation by a user is confirmed, the control device is configured:
if the input is a first input after the water dispenser has been turned on,
to carry out: the sterilization operation; an energy saving operation in which the heater is maintained off after the completion of the sterilization operation, and turned on when a prescribed period of time has elapsed since the input; and a reservation control configured to update reserved times determined by the timer control according to the predetermined routine based on a reference time at which the input is made; and
if the input is a second or subsequent input after the water dispenser is turned on, to compare an elapsed time since an input of the predetermined signal which initiated a last sterilization operation until said second or subsequent input with a threshold value; and
to carry out the sterilization operation, the energy saving operation, and the reservation control, if a relation: elapsed time>threshold value is satisfied; and to carry out the energy saving operation without performing the sterilization operation and the reservation control, if a relation: elapsed time≦threshold value is satisfied.

2. The water dispenser according to claim 1, wherein the predetermined routine is configured to determine an initial one of the reserved times at a time which is later than 24 hours after the reference time by a specified period of time, and determine each of second and later ones of the reserved times at a time which is 24 hours after a last one of the reserved times.

3. The water dispenser according to claim 2, wherein the specified period of time is determined to be 2 hours or less.

4. The water dispenser according to claim 1, wherein the threshold value is determined to be 14 hours.

5. The water dispenser according to claim 1, wherein the prescribed period of time is determined to be 6 hours.

6. The water dispenser according to claim 2, wherein the threshold value is determined to be 14 hours.

7. The water dispenser according to claim 3, wherein the threshold value is determined to be 14 hours.

8. The water dispenser according to claim 2, wherein the prescribed period of time is determined to be 6 hours.

9. The water dispenser according to claim 3, wherein the prescribed period of time is determined to be 6 hours.

10. The water dispenser according to claim 4, wherein the prescribed period of time is determined to be 6 hours.

11. The water dispenser according to claim 6, wherein the prescribed period of time is determined to be 6 hours.

12. The water dispenser according to claim 7, wherein the prescribed period of time is determined to be 6 hours.
